(19) United States
(12) Patent Application Publication
(10) Pub. No.: US 2011/0187789 A1
(43) Pub. Date: Aug. 4, 2011

(54) INK SET AND IMAGE FORMING METHOD

(75) Inventor: Ryo SAITO, Kanagawa (JP)

(73) Assignee: FUJIFILM CORPORATION, Tokyo (JP)

(21) Appl. No.: 13/014,724

(22) Filed: Jan. 27, 2011

(30) Foreign Application Priority Data
Feb. 4, 2010 (JP) 2010-023258

(51) Int. Cl. B41J 2/015; C09D 11/02

(52) U.S. Cl. 347/21; 106/31.13; 106/31.6; 347/100

(57) ABSTRACT

The invention provides an ink set including an ink containing at least a coloring material, and a treatment liquid including at least one first aggregating agent selected from the following group (A) and at least one second aggregating agent selected from the following group (B), which is different from the group (A):
(A) orthophosphoric acid, phosphorous acid, hypophosphorous acid, pyrophosphoric acid, tartaric acid and salts thereof; and
(B) an organic acid having a first dissociation constant pKa of 3.2 or less, or a salt thereof (b-1), an inorganic acid or a salt thereof (b-2), and a polyvalent metal salt (b-3).

### CROSS-REFERENCE TO RELATED APPLICATIONS

This application is based on and claims priority under 35 USC 119 from Japanese Patent Application No. 2010-023258 filed on Feb. 4, 2010, the disclosure of which is incorporated by reference herein.

### BACKGROUND

1. Technical Field

The present invention relates to an ink set and an image forming method.

2. Related Art

An inkjet recording method is a method of performing recording by ejecting an ink in the form of liquid droplets from a number of nozzles formed on an inkjet head toward a recording medium, and fixing the ink on the recording medium. As a technology of rapidly fixing an ink on a recording medium in order to obtain high quality images with high resolution, investigations have been carried out on the use of a treatment liquid containing a compound capable of accelerating the aggregation of ink (also referred to as a fixing liquid or a reaction liquid).

In connection with the issue described above, there has been disclosed a fixing liquid for ink which having a tendency to precipitate or aggregate at a pH of about 6 or lower, which is characterized by containing at least one organic acid and optionally containing at least one salt of a polymeric acid. This fixing liquid is considered to be excellent in the resistance to water of ink (toughness against water) (see, for example, Japanese Patent Application Laid-Open (JP-A) No. 2002-29141).

Furthermore, in recent years, investigations have been carried out on a technology of further enhancing the aggregation speed of an ink on a recording medium, under a demand for an increase in the speed of inkjet recording. For example, there has been disclosed an ink set for inkjet recording which includes an ink composition containing self-dispersing polymer fine particles, and a reaction liquid containing an organic acid (see, for example, JP-A No. 2009-190232).

### SUMMARY

According to an aspect of the present invention, there is provided

an ink set including an ink containing at least a coloring material, and a treatment liquid including at least one first aggregating agent selected from the following group (A) and at least one second aggregating agent selected from the following group (B), which is different from the group (A):

(A) orthophosphoric acid, phosphorous acid, hypophosphorous acid, pyrophosphoric acid, tartaric acid and salts thereof; and

(B) an organic acid having a first dissociation constant pKa of 3.2 or less, or a salt thereof (b-1), an inorganic acid or a salt thereof (b-2), and a polyvalent metal salt (b-3).

### DETAILED DESCRIPTION

<<Ink Set>>

An ink set of the present invention is an ink set which includes an ink containing at least a coloring material; and a treatment liquid containing at least one first aggregating agent selected from the following group (A) shown below, and at least one second aggregating agent selected from the following group (B) shown below, which is different from the group (A):

(A) orthophosphoric acid, phosphorous acid, hypophosphorous acid, pyrophosphoric acid, tartaric acid, and salts thereof; and

(B) an organic acid having a first dissociation constant pKa of 3.2 or less, or a salt thereof (b-1), an inorganic acid or a salt thereof (b-2), and a polyvalent metal salt (b-3).

The ink set of the invention having such a constitution has satisfactory ink aggregatability and is capable of suppressing the occurrence of gloss unevenness in the image areas.

The occurrence of gloss unevenness in the image areas is believed to be caused by the precipitation of formations containing calcium at the image surface, since when the sites where gloss unevenness occurs are compared with sites where gloss unevenness does not occur, the sites where gloss unevenness occurs are detected to have high calcium contents.

The formations containing calcium thus precipitated are thought to be originating from the calcium salt that is formed when an acid contained in the treatment liquid dissolves calcium carbonate contained in the coating layer of a coated paper, and the dissolved calcium reacts with the acid in the treatment liquid. It is speculated that if the water-solubility (degree of solubility in water) of this calcium salt is high, when an ink is applied later, the calcium salt is dissolved by an aqueous solvent of the ink, and concomitantly with the drying and absorption into a recording medium of the aqueous solvent, formations containing calcium precipitate out on the recording medium surface in the image areas.

The treatment liquid included in the ink set of the invention contains at least one first aggregating agent selected from the compounds of the group (A), but the calcium salt that is formed as a result of a reaction between this first aggregating agent and calcium carbonate, has low solubility in water. When a calcium salt having low solubility in water is present on the recording medium, it is speculated that when an ink is applied later, dissolution of this calcium salt as well as other calcium salts in the aqueous solvent of the ink is suppressed, and accordingly, precipitation of formations containing calcium on the recording medium surface in the image areas is suppressed.

At the same time, the treatment liquid included in the ink set of the invention contains at least one second aggregating agent selected from the compounds of the group (B), which is different from the compounds of the group (A). When the first aggregating agent and the second aggregating agent are used together, high aggregatability of the ink may be maintained, an increase in the aggregation speed is made possible, and the images thus formed are sharp.

Therefore, the ink set of the invention which contains the first aggregating agent and the second aggregating agent in the treatment liquid, is capable of maintaining high aggregatability of ink and suppressing the occurrence of gloss unevenness at the image areas.

The gloss unevenness at the image areas becomes conspicuous when, for example, a recorded image is touched by a finger (this phenomenon is referred to as “finger contact gloss unevenness”), and this poses a problem in terms of the handleability of recording media. However, the ink set of the invention may effectively suppress the occurrence of finger contact gloss unevenness.

Furthermore, when the water-solubility of the calcium salt that is formed as a result of application of the treatment liquid is high, the coating layer of the coated paper is weakened immediately after the application of ink, and peeling of the coating layer may occur, or the scratch resistance of the images obtained immediately after the image recording may be deteriorated. However, the ink set of the invention may effectively prevent peeling of the coating layer and enhance the scratch resistance of the images obtained immediately after image recording.

In addition, the treatment liquid included in the ink set of the invention has satisfactory storage stability.

The ink set of the invention is suitable for the use in the image formation according to an inkjet method, and is particularly preferable as an ink set to be used in the image forming method of the invention that will be described below.

The ink set of the invention may be used in the form of an ink cartridge that holds the ink and the treatment liquid combinedly or separately, and even from the viewpoint of convenient handling, it is preferable to use the ink set in the form of ink cartridge. The ink cartridge formed by including an ink set is well known in the related art, and an ink cartridge may be produced by appropriately using a known method.

Hereinafter, the treatment liquid and the ink that are used in the ink set of the invention will be described in detail.

<Treatment Liquid>

The treatment liquid included in the ink set of the invention may be constituted to contain at least one first aggregating agent selected from the following group (A) shown below, and at least second aggregating agent selected from the following group (B) shown below, which is different from the group (A), and if necessary, to contain other components.

(A) Orthophosphoric acid, phosphorous acid, hypophosphorous acid, pyrophosphoric acid, tartaric acid, and salts thereof.

(B) An organic acid having a first dissociation constant pKa of 3.2 or less, or a salt thereof (b-1), an inorganic acid or a salt thereof (b-3), and a polyvalent metal salt (b-3).

The first aggregating agent (may be referred to as component (A)) and the second aggregating agent (may be referred to as component (B)) generate aggregation when brought into contact with the ink. When the ink ejected by an inkjet method is mixed with the treatment liquid, aggregation of the pigments and the like that are stably dispersed in the ink is accelerated.

The treatment liquid according to the invention maintains high ink aggregatability and suppresses the occurrence of gloss unevenness in the image areas, by containing the first aggregating agent and the second aggregating agent.

[First Aggregating Agent]

The first aggregating agent is at least one compound selected from orthophosphoric acid, phosphorous acid, hypophosphorous acid, pyrophosphoric acid, tartaric acid and salts thereof. The first aggregating agent may be used singly, or two or more kinds may be used in mixture.

The respective calcium salts of orthophosphoric acid, phosphorous acid, hypophosphorous acid, pyrophosphoric acid and tartaric acid all have low solubility in water. Although the reason is not clearly known, when those calcium salts having low solubility in water are formed as a result of application of the treatment liquid, generation of other calcium salts having high water-solubility is suppressed, so that when an ink is applied later, dissolution of the ink by an aqueous solvent is suppressed. Thus, it is speculated that accordingly, the precipitation of formations containing calcium on the recording medium surface in the image areas is suppressed.

The content of the first aggregating agent in the treatment liquid is preferably from 5% by mass to 30% by mass, more preferably from 5% by mass to 25% by mass, and particularly preferably from 15% by mass to 25% by mass, relative to the total mass of the treatment liquid, from the viewpoint of aggregating effects.

When the content of the first aggregating agent in the treatment liquid is set in the range mentioned above, gloss unevenness is suppressed, and a satisfactory physical strength of drawn images is obtained.

[Second Aggregating Agent]

The second aggregating agent is at least one compound selected from an organic acid having a first dissociation constant pKa of 3.2 or less or a salt thereof (b-1), an inorganic acid or a salt thereof (b-2), and a polyvalent metal salt (b-3), and is a compound different from the compounds of the group (A). The second aggregating agent may be used singly, or two or more kinds may be used in mixture.

(b-1)

The organic acid having a first dissociation constant pKa of 3.2 or less or a salt thereof, which is a compound different from the compounds of the group (A), means an organic acid having a first dissociation constant pKa of 3.2 or less, which is other than tartaric acid, or a salt thereof. If the first dissociation constant pKa of the organic acid is greater than 3.2, the aggregatability of the ink may be insufficient.

Unless particularly stated otherwise, the first dissociation constant pKa according to the invention is a value measured at 25° C., but depending on the type of the organic acid, it is a value measured at a temperature other than 25° C. Examples of the organic acid having a first dissociation constant pKa of 3.2 or less include those described in pages 340 to 343 of “Kagaku Binran (Handbook of Chemistry)—Fundamentals II, Revised 5^{th} Edition” (edited by the Chemical Society of Japan, Maruzen Co., Ltd., 2004).

Specific examples of the organic acid other than tartaric acid, having a first dissociation constant pKa of 3.2 or less, or a salt thereof, include the compounds listed below. Unless particularly stated otherwise, the first dissociation constant pKa is a value measured at 25° C.

Malonic acid (pKa=2.60), citric acid (pKa=2.90), isocitric acid (pKa=3.09), oxaloacetic acid (pKa=2.55), glyoxylic acid (pKa=2.98), o-chlorobenzoic acid (pKa=2.95), chloroacetic acid (pKa=2.66), cyanoacetic acid (pKa=2.65), cyclopropane-1,1-dicarboxylic acid (pKa=1.68), dichloroacetic acid (pKa=1.30, 20° C.), 2,3-difluorobenzoic acid (pKa=3.10), 2,5-difluorobenzoic acid (pKa=3.11), oxalic acid (pKa=1.04), trichloroacetic acid (pKa=0.46), trimethylammonioacetic acid (pKa=1.87), o-nitrobenzoic acid (pKa=2.87), nitroacetic acid (pKa=1.34, 18° C.), pyruvic acid (pKa=2.34), phenoxyacetic acid (pKa=2.93), phthalic acid (pKa=2.75), fumaric acid (pKa=3.07), 2-furanecarboxylic acid (pKa=2.98), fluoroacetic acid (pKa=2.55, 20° C.), bromoacetic acid (pKa=2.82, 20° C.), 2-bromopropionic acid (pKa=2.97, 20° C.), bromomalonic acid (pKa=2.53, 30° C.), pentafluorobenzoic acid (pKa=1.48), maleic acid (PKa=1.84), mandelic acid (pKa=3.18), methylmalonic acid (pKa=2.89), iodoacetic acid (pKa=2.90, 20° C.), o-anilinesulfonic acid (pKa=0.40), p-anilinesulfonic acid (pKa=3.02), o-aminobenzoic acid (pKa=1.97), 4-aminosalicylic acid (pKa=2.05), and salts thereof.

Among the compounds described above, compounds having a carboxyl group are preferred from the viewpoint of the aggregation speed of the ink composition.

These compounds may be used singly, or may be used in combination of two or more kinds.

(b-2)

The inorganic acid or a salt thereof, which is a compound different from the compounds of the group (A), means an inorganic acid other than orthophosphoric acid, phosphorous acid, hypophosphorous acid or pyrophosphoric acid, or a salt thereof.

Specific examples include nitric acid, nitrous acid, sulfuric acid, hydrochloric acid, metaphosphoric acid (polyphosphoric acid), and salts thereof.

Among the compounds described above, nitric acid, hydrochloric acid and salts thereof are preferred from the viewpoint of aggregatability, or storage stability of the treatment liquid.

These compounds may be used singly, or may be used in combination of two or more kinds.

(b-3)

The polyvalent metal salt which is a different from the compounds of the group (A), means a polyvalent metal salt other than the respective polyvalent metal salts of orthophosphoric acid, phosphorous acid, hypophosphorous acid, pyrophosphoric acid and tartaric acid.

Specific examples include the salts of alkaline earth metals of Group 2 of the Periodic Table (for example, magnesium and calcium), transition metals of Group 3 of the Periodic Table (for example, lanthanum), cations of Group 13 of the Periodic Table (for example, aluminum), and lanthanides (for example, neodymium), and the salts other than the salts of orthophosphoric acid, phosphorous acid, hypophosphorous acid, pyrophosphoric acid and tartaric acid.

In addition, the polyvalent metal salt of an organic acid other than tartaric acid, having a first dissociation constant pKa of 3.2 or less, also belongs to the group (b-1); however, since this salt is a polyvalent metal salt, this salt is considered to belong to the group (b-3). Likewise, the polyvalent metal salts of inorganic acids other than orthophosphoric acid, phosphorous acid, hypophosphorous acid and pyrophosphoric acid belong to the group (b-2), but these salts, being polyvalent metal salts, are considered to belong to the group (b-3).

Suitable examples of the polyvalent metal salt according to the invention include carboxylic acid salts (salts of formic acid, acetic acid, benzoic acid and the like), nitrates, chlorides and thiocyanates. Among them, preferred examples include calcium salts or magnesium salts of carboxylic acids (salts of formic acid, acetic acid, benzoic acid and the like), calcium salt or magnesium salt of nitric acid, calcium chloride, magnesium chloride, and calcium salt or magnesium salt of thiocyanic acid.

These compounds may be used singly, or may be used in combination of two or more kinds.

The content of the second aggregating agent in the treatment liquid is preferably from 5% by mass to 30% by mass, more preferably from 5% by mass to 25% by mass, and particularly preferably from 15% by mass to 25% by mass, relative to the total mass of the treatment liquid, from the viewpoint of the aggregation effects.

When the content of the second aggregating agent in the treatment liquid is set in the range described above, there may be obtained images drawn with high accuracy, which has an excellent aggregating effect, is free of bleeding, and has controlled dot diameter.

From the viewpoint of having satisfactory ink aggregatability, suppressing the occurrence of gloss unevenness in the image areas, enhancing the scratch resistance of images obtained immediately after printing, and thereby preventing the rusting or corrosion of the members used in the inkjet recording apparatus, the treatment liquid according to the invention is preferably a combination including orthophosphoric acid and/or tartaric acid as the first aggregating agent, and including an organic acid other than tartaric acid, having a first dissociation constant pKa of 3.2 or less, or a salt thereof, as the second aggregating agent; or a combination including orthophosphoric acid and/or tartaric acid as the first aggregating agent, and including a polyvalent metal salt as the second aggregating agent.

In the treatment liquid according to the invention, from the viewpoint of the ink aggregatability and the suppression of gloss unevenness, the mass ratio of the first aggregating agent and the second aggregating agent is preferably 1:9 to 9:1, more preferably 2:8 to 8:2, and even more preferably 3:7 to 7:3.

The treatment liquid according to the invention may also use a aggregating agent that has different aggregating effects, such as an organic acid different from the first aggregating agent and the second aggregating agent, in combination with the first aggregating agent and the second aggregating agent, and this additional aggregating agent may be used according to the purposes such as enhancement of the stability of the treatment liquid, and suppression of rusting or corrosion of the members used in the inkjet recording apparatus. In addition to that, it is also preferable to use an antirust agent, an antifungal agent, a pH buffering agent, or the like in combination.

—Properties of Treatment Liquid—

The pH (25° C.±1° C.) of the treatment liquid is preferably 3.5 or less, more preferably 0.5 to 2.5, even more preferably 0.7 to 2.3, and particularly preferably 0.8 to 2.0, from the viewpoint of the aggregation speed of the ink. In this case, the pH (25° C.±1° C.) of the ink is preferably 7.0 or higher, and more preferably 7 to 10.

Inter alia, according to the invention, it is preferable that the pH (25° C.±1° C.) of the ink be 7.0 or higher, and the pH (25° C.±1° C.) of the treatment liquid be 3.5 or less, from the viewpoint of the image density, resolution, and an increase in the speed of inkjet recording.

The viscosity of the treatment liquid is preferably in the range of from 1 to 30 mPa·s, more preferably from 1 to 20 mPa·s, even more preferably from 2 to 15 mPa·s, and particularly preferably from 2 to 10 mPa·s, from the viewpoint of the aggregation speed of the ink. Here, the viscosity is a value measured using a viscometer (trade name: TV-22, manufactured by Toki Sangyo Co., Ltd.) under the conditions of 20° C.

The static surface tension of the treatment liquid according to the invention is preferably from 40 to 50 mN/m, from the viewpoint of the uniformity of recorded images. Here, the static surface tension is a value measured by the Wilhelmy method using a platinum plate, under the conditions of 25° C. using an automatic surface tensiometer (trade name: CBVP-Z, manufactured by Kyowa Interface Science Co., Ltd.).

Furthermore, the dynamic surface tension of the treatment liquid according to the invention is a value measured at 25° C. using a bubble pressure dynamic surface tensiometer (trade name: BP2, manufactured by Kruss GmbH).

The treatment liquid according to the invention is preferably such that when the values of the dynamic surface tension at a surface lifetime of 100 ms and 10000 ms are designated as γ0.1 and γ10, respectively, the dynamic surface tension γ0.1 is 40 to 50 mN/m, and the ratio of dynamic surface tension, γ (=γ0.1/γ10), is 1.01 to 1.10, and more preferably such that the dynamic surface tension γ0.1 is 40 to 50 mN/m, and the ratio of dynamic surface tension, γ (=γ0.1/γ10), is 1.01 to 1.08.

When the static surface tension and the dynamic surface tension of the treatment liquid are set in the range described above, the recorded images formed as a result of contact with ink have an improved size of drawn dots and improved uniformity of shape.

The static surface tension and the dynamic surface tension may be regulated by selecting hydrophilic organic solvents that are capable of obtaining the characteristics described above, singly or in combination of multiple kinds.

[Organic Solvent]

The treatment liquid according to the invention preferably contains at least one organic solvent, and it is more preferable that the organic solvent be a hydrophilic organic solvent. When the treatment liquid contains the organic solvent (particularly, hydrophilic organic solvent), the static surface tension and the dynamic surface tension may be regulated, and prevention of drying and acceleration of penetration may be promoted.

Specific examples of the hydrophilic organic solvent include the hydrophilic organic solvents used in the ink that will be described below. The organic solvents may be used singly, or two or more kinds may be used in mixture.

There are no particular limitations on the content of the organic solvent in the treatment liquid according to the invention, but the content is from 1% by mass to 30% by mass, and more preferably from 5% by mass to 15% by mass.

When the content of the organic solvent in the treatment liquid is set from 1% by mass to 30% by mass, it is preferable from the viewpoint of regulating the static surface tension and the dynamic surface tension, preventing drying, accelerating penetration, suppressing the reaction between the acid and the composition in the recording medium, and the like.

[Surfactant]

The treatment liquid according to the invention may contain at least one surfactant. The surfactant is used as a surface tension adjusting agent. Examples of the surface tension adjusting agent include a nonionic surfactant, a cationic surfactant, an anionic surfactant, and a betaine surfactant.

Specific examples of the surfactant include the surfactants used in the ink that will be described later. The surfactant may be used singly, or two or more kinds may be used in mixture.

[Water]

The treatment liquid according to the invention preferably contains water. There are no particularly limitations on the amount of water that is contained, but the content is preferably from 10% by mass to 99% by mass, more preferably from 30% by mass to 80% by mass, and even more preferably from 50% by mass to 70% by mass.

[Other Additives]

The treatment liquid according to the invention may further contain other additives in addition to the components described above. Examples of the other additives include known additives such as a discoloration preventing agent, an emulsion stabilizer, a penetration promoting agent, an ultraviolet absorbing agent, an antiseptic agent, an antifungal agent, a pH adjusting agent, a defoaming agent, a viscosity adjusting agent, an antirust agent, and a chelating agent. These various additives may be directly added after the preparation process, or may be added during the preparation process.

<Ink>

The ink (hereinafter, may be referred to as “ink composition”) used in the ink set of the invention contains at least one coloring material, and may be constituted to include, if necessary, polymer particles, a hydrophilic organic solvent, a surfactant, water and other additives.

[Coloring Material]

The ink used in the ink set of the invention may contain a known dye, pigment or the like as a coloring material, without any particular limitation. The ink according to the invention may be prepared into an ink of yellow color, an ink of magenta color, an ink of cyan color, an ink of black color, an ink of red color, an ink of green color, and an ink of blue color, by varying the color phase of the coloring material.

The coloring material is preferably a coloring material that is almost insoluble or sparingly soluble in water, from the viewpoint of ink colorability. Specific examples of the coloring material include various pigments, dispersion dyes, oil-soluble dyes, and colorants that form J-associates.

The coloring material is preferably a water-insoluble pigment, and more preferably a water-insoluble pigment that has been surface-treated with a dispersant. Here, the water-insoluble pigment refers to a pigment that is almost insoluble or sparingly soluble in water, and specifically means that the amount of the pigment dissolved in water at 25° C. is 0.5% by mass or less.

(Pigment)

There are no particular limitations on the type of the pigment according to the invention, and conventionally known organic and inorganic pigments may be used. Examples include polycyclic pigments such as azo lakes, azo pigments, phthalocyanine pigments, perylene and perinone pigments, anthraquinone pigments, quinacridone pigments, dioxazine pigments, diketopyrrolopyrrole pigments, thioindigo pigments, isoindolinone pigments, and quinophthalone pigments; dye lakes such as basic dye lakes and acidic dye lakes; organic pigments such as nitro pigments, nitroso pigments, aniline black, and daylight fluorescent pigments; and inorganic pigments such as titanium oxide, iron oxide series, and carbon black series. Furthermore, any pigment that is not described in the Color Index may also used as long as the pigment is dispersible in an aqueous phase. The pigments described above which have been surface-treated with a surfactant or a polymeric dispersant, or graft carbon and the like may also be used. Among the pigments mentioned above, it is particularly preferable to use an azo pigment, a phthalocyanine pigment, an anthraquinone pigment, a quinacridone pigment, or a carbon black-based pigment. Specifically, those pigments described in paragraph [0142] to paragraph [0145] of JP-A No. 2007-100071 may be used.

(Dispersant)

When the coloring material used in the ink according to the invention is a pigment, it is preferable that the pigment be dispersed in a water-based solvent by means of a dispersant. The dispersant may be a polymeric dispersant or a low molecular weight surfactant type dispersant. The polymeric dispersant may be a water-soluble dispersant or a non-water-soluble dispersant.

The low molecular weight surfactant type dispersant (hereinafter, may be referred to as “low molecular weight dispersant”) is capable of stably dispersing a pigment in a water-based solvent while maintaining the ink less viscous. The low molecular weight dispersant as used herein is a dispersant having a molecular weight of 2000 or less. The molecular weight of the low molecular weight dispersant is preferably 100 to 2000, and more preferably 200 to 2000.

The low molecular weight dispersant has a structure which includes a hydrophilic group and a hydrophobic group. The hydrophilic group and the hydrophobic group may be such that one or more of each group are independently included in one molecule, and plural kinds of hydrophilic groups and hydrophobic groups may be carried by a dispersant molecule. The dispersant may also have an appropriate linking group for linking the hydrophilic group and the hydrophobic group.

Examples of the hydrophilic group include an anionic group, a cationic group, a nonionic group, and betaine type group combining these.

There are no particular limitations on the anionic group as long as the group has a negative charge, and the anionic group is preferably a phosphoric acid group, a phosphonic acid group, a phosphinic acid group, a sulfuric acid group, a sulfonic acid group, a sulfinic acid group, or a carboxylic acid group, more preferably a phosphoric acid group or a carboxylic acid group, and even more preferably a carboxylic acid group.

There are no particular limitations on the cationic group as long as the group has a positive charge, and the cationic group is preferably an organic cationic substituent, more preferably a cationic group containing nitrogen or phosphorus, and even more preferably a cationic group containing nitrogen. Among them, a pyridinium cation or an ammonium cation is particularly preferred.

There are no particular limitations on the nonionic group as long as the group has neither a negative charge nor a positive charge, and examples thereof include polyalkylene oxide, polyglycerin, and some of sugar units.

According to the invention, the hydrophilic group of the low molecular weight dispersant is preferably an anionic group, from the viewpoint of the dispersion stability and aggregatability of the pigment.

When the low molecular weight dispersant has an anionic hydrophilic group, the pKa of the low molecular weight dispersant is preferably 3 or greater, from the viewpoint of accelerating the aggregation reaction by bringing the dispersant into contact with an acidic treatment liquid. The pKa of the low molecular weight dispersant according to the invention is a value experimentally determined from a titration curve obtained by titrating a liquid having the low molecular weight dispersant dissolved in a solution of tetrahydrofuran-water=3:2 (V/V) at a concentration of 1 mmol/L, with an acidic or alkaline aqueous solution.

In theory, if the pKa of the low molecular weight dispersant is 3 or greater, when the dispersant is brought into contact with a treatment liquid having a pH of about 3, 50% or more of the anionic groups are in a non-dissociated state. Therefore, the water-solubility of the low molecular weight dispersant is markedly decreased, and an aggregation reaction occurs. That is, the aggregational reactivity is enhanced. From this viewpoint, it is preferable that the low molecular weight dispersant have a carboxylic acid group as an anionic group.

On the other hand, the hydrophobic group may have any of a hydrocarbon-based structure, a fluorocarbon-based structure and a silicone-based structure, and a hydrophobic group having a hydrocarbon-based structure is particularly preferred. Furthermore, such a hydrophobic group may have a linear structure or a branched structure. The hydrophobic group may have a structure having a single chain or a structure having two or more chains. In the case of a structure having two or more chains, the dispersant may have plural kinds of hydrophobic groups.

The hydrophobic group is preferably a hydrocarbon group having 2 to 24 carbon atoms, more preferably a hydrocarbon group having 4 to 24 carbon atoms, and even more preferably a hydrocarbon group having 6 to 20 carbon atoms.

Among polymeric dispersants, a hydrophilic polymer compound may be used as the water-soluble dispersant. Examples of a naturally occurring hydrophilic polymer compound include plant polymers such as gum arabic, tragacanth gum, guar gum, karaya gum, locust bean gum, arabinogalactone, pectin, and quince seed starch; seaweed-based polymers such as alginic acid, carrageenan and agar; animal polymers such as gelatin, casein, albumin, and collagen; and microbial polymers such as xanthene gum and dextran.

Examples of a hydrophilic polymer compound obtained by chemically modifying a natural product as a raw material, include cellulosic polymers such as methylcellulose, ethylcellulose, hydroxyethylcellulose, hydroxypropylcellulose and carboxymethylcelluose; starch-based polymers such as sodium starch glycolate and sodium starch phosphate ester; and seaweed-based polymers such as alginic acid propylene glycol esters.

Furthermore, examples of a synthetic hydrophilic polymer compound include vinylic polymers such as polyvinyl alcohol, polyvinylpyrrolidone, and polyvinyl methyl ether; acrylic resins such as polyacrylamide, polyacrylic acid or alkali metal salts thereof, and water-soluble styrene acrylic resins; water-soluble styrene maleic acid resins, water-soluble vinylnaphthalene acrylic resins, water-soluble vinylnaphthalene maleic acid resins, polyvinylpyrrolidone, polyvinyl alcohol, alkali metal salts of β-naphthalenesulfonic acid-formalin condensate, and polymer compounds having, in a side chain, a salt of a quaternary ammonium or a cationic functional group such as an amino group.

Among these, from the viewpoint of the dispersion stability and aggregatability of the pigment, a polymer compound containing a carboxyl group is preferred, and for example, acrylic resins such as a water-soluble styrene acrylic resin, and polymer compounds containing a carboxylic group such as a water-soluble styrene-maleic acid resin, a water-soluble vinylnaphthalene-acrylic resin, and a water-soluble vinylnaphthalene-maleic acid resin are particularly preferred.

As the non-water-soluble dispersant among the polymeric dispersants, a polymer having both a hydrophobic portion and a hydrophilic portion may be used. Examples of the polymer include a styrene-(meth)acrylic acid copolymer, a styrene-(meth)acrylic acid-(meth)acrylic acid ester copolymer, a (meth)acrylic acid ester-(meth)acrylic acid copolymer, a polyethylene glycol (meth)acrylate-(meth)acrylic acid copolymer, and a styrene-maleic acid copolymer.

The weight average molecular weight of the polymeric dispersant is preferably 3,000 to 200,000, more preferably 5,000 to 100,000, even more preferably 5,000 to 80,000, and particularly preferably 10,000 to 60,000.

The mixing mass ratio of the pigment and the dispersant (pigment:dispersant) is preferably in the range of from 1:0.06 to 1:3, more preferably in the range of from 1:0.125 to 1:2, and even more preferably from 1:0.125 to 1:1.5.

The ink according to the invention preferably contains a pigment and a dispersant from the viewpoint of the light resistance or quality of the image, and the ink more preferably contains an organic pigment and a polymeric dispersant, and particularly preferably contains an organic pigment and a polymeric dispersant containing a carboxyl group. Among them, from the viewpoint of aggregatability and ink fixability, the pigment is preferably a water-insoluble pigment coated with a polymeric dispersant (preferably, a polymeric dispersant having a carboxyl group), and more preferably a water-insoluble pigment coated with an acrylic polymer. The acrylic polymer is preferably, for example, an acrylic resin such as a water-soluble styrene acrylic resin, a water-soluble styrene maleic acid resin, a water-soluble vinylnaphthalene acrylic resin, or a water-soluble vinylnaphthalene maleic acid resin.

Furthermore, in regard to the acid value of the polymer particles (preferably, self-dispersing polymer particles) that will be described below, from the viewpoint of aggregatability, it is preferable that the acid value of the polymeric dispersant be high.

The volume average particle size of the pigment coated with a polymeric dispersant is preferably from 10 to 200 nm, more preferably from 10 to 150 nm, and even more preferably from 10 to 100 nm. When the average particle size is 200 nm or less, the color reproducibility is satisfactory, and the droplet ejection properties are satisfactory when droplets are ejected by an inkjet method. When the average particle size is 10 nm or greater, light resistance is satisfactory. Furthermore, there are no particular limitations on the particle size distribution of the pigment coated with a polymeric dispersant, and any of a broad particle size distribution and a monodisperse particle size distribution may be used. Two or more kinds of pigments having a monodisperse particle size distribution may be used in mixture.

In addition, the average particle size and the particle size distribution of the pigment coated with a polymeric dispersant are determined by making measurements by a dynamic light scattering method using a NanoTrac particle size distribution analyzer (trade name: UPA-EX150, manufactured by Nikkiso Co., Ltd.).

The content of the pigment in the ink composition is preferably from 1% by mass to 25% by mass, more preferably from 2% by mass to 20% by mass, even more preferably from 5% by mass to 20% by mass, and particularly preferably from 5% by mass to 15% by mass, based on the ink composition, from the viewpoint of the image density.

The pigment may be used singly, or two or more kinds may be used in combination.

Furthermore, the ink according to the invention may contain a dye together with the pigment. When the ink contains a dye, a dye retained on a water-insoluble carrier may be used as a water-insoluble coloring material. Any known dye may be used without particular limitation, and for example, the dyes described in JP-A No. 2001-115066, JP-A No. 2001-335714, JP-A No. 2002-249677 and the like may be suitably used for the invention. Furthermore, there are no particular limitations for the carrier as long as the carrier is insoluble in water or sparingly soluble in water, and an inorganic material, an organic material and a composite material of the foregoing materials may be used. Specifically, the carriers described in JP-A No. 2001-181549, JP-A No. 2007-169418 and the like may also be suitably used for the invention.

The carrier retaining a dye (water-insoluble coloring material) may be used as an aqueous dispersion using a dispersant. As the dispersant, those dispersants mentioned above may be suitably used.

[Polymer Particles]

The ink used in the ink set of the invention may contain at least one kind of polymer particles. When the ink contains polymer particles, the scratch resistance of the images thus formed is effectively enhanced.

Examples of the polymer particles include the particles of a resin having an anionic group, such as a thermoplastic, thermosetting or modified acrylic resin, an epoxy-based resin, a polyurethane-based resin, a polyether-based resin, a polyamide-based resin, an unsaturated polyester-based resin, a phenolic resin, a silicone-based resin or a fluororesin; a polyvinyl-based resin such as a vinyl chloride resin, a vinyl acetate resin, polyvinyl alcohol or polyvinyl butyral; a polyester-based resin such as an alkyd resin or a phthalic resin; an amino-based material such as a melamine resin, a melamine formaldehyde resin, an aminoalkyd co-condensated resin, a urea resin or a urea resin; or a copolymer or a mixture of those resins. Among these, the anionic acrylic resin may be obtained by, for example, polymerizing an acrylic monomer having an anionic group (anionic group-containing acrylic monomer) and if necessary, another monomer that is co-polymerizable with the anionic group-containing acrylic monomer, in a solvent. Examples of the anionic group-containing acrylic monomer include acrylic monomers having one or more selected from the group consisting of a carboxyl group, a sulfonic acid group and a phosphonic group, and among them, an acrylic monomer having a carboxyl group (for example, acrylic acid, methacrylic acid, crotonic acid, ethacrylic acid, propylacrylic acid, isopropylacrylic acid, itaconic acid or fumaric acid) is preferred, while acrylic acid or methacrylic acid in particular is preferred.

The polymer particles are preferably self-dispersing polymer particles from the viewpoint of ejection stability and liquid stability (particularly, dispersion stability) in the case of using a pigment, and more preferably self-dispersing polymer particles having a carboxyl group. The self-dispersing polymer particles mean the particles of a water-insoluble polymer which may be brought to a dispersed state in an aqueous medium by the functional group (particularly an acidic group or a salt thereof) carried by the polymer itself in the absence of other surfactants, and which does not contain a free emulsifying agent.

The term dispersed state includes both an emulsified state (emulsion) in which the water-insoluble polymer is dispersed in a liquid state in an aqueous medium, and a dispersed state (suspension) in which the water-insoluble polymer is dispersed in a solid state in an aqueous medium. The water-insoluble polymer is preferably a water-insoluble polymer that is capable of being brought to a dispersed state in which the water-insoluble polymer is dispersed in a solid state, from the viewpoint of the aggregation speed and fixability of the resulting ink composition.

The dispersed state of self-dispersing polymer particles means a state in which, even after a solution prepared by dissolving 30 g of a water-insoluble polymer in 70 g of an organic solvent (for example, methyl ethyl ketone), a neutralizing agent capable of neutralize 100% of the salt-forming group of the water-insoluble polymer (if the salt-forming group is anionic, the neutralizing agent is sodium hydroxide; and if cationic, acetic acid), and 200 g of water are mixed and stirred (apparatus: stirring blade-equipped stirring apparatus, speed of rotation 200 rpm, for 30 minutes, 25° C.), and then the organic solvent is removed from the mixed liquid, the emulsified state or dispersed state is maintained stable for at least one week at 25° C., and the occurrence of precipitates cannot be confirmed by visual inspection.

Furthermore, the water-insoluble polymer means a polymer which gives an amount of dissolution of 10 g or less when the polymer is dried at 105° C. for 2 hours and then is dissolved in 100 g of water at 25° C., and the amount of dissolution is preferably 5 g or less, and more preferably 1 g or less. The amount of dissolution is an amount of dissolution obtainable when the water-insoluble polymer is neutralized 100% with sodium hydroxide or acetic acid in accordance with the type of the salt-forming group of the water-insoluble polymer.

The aqueous medium is constituted to include water, and may contain a hydrophilic organic solvent as necessary. According to the invention, the aqueous medium is preferably constituted to include water and a hydrophilic organic solvent at a proportion of 0.2% by mass or less based on water, and more preferably composed only of water.

There are no particular limitations on the main chain skeleton of the water-insoluble polymer, and for example, a vinyl polymer, or a condensed polymer (epoxy resin, polyester, polyurethane, polyamide, cellulose, polyether, polyurea, polyimide, polycarbonate or the like) may be used. Among them, a vinyl polymer is particularly preferred.

Suitable examples of the vinyl polymer and the monomer that constitutes the vinyl polymer include those described in JP-A No. 2001-181549 and JP-A No. 2002-88294. Furthermore, a vinyl polymer to which a dissociable group has been introduced at the terminals of the polymer chain by radical polymerization of a vinyl monomer using a chain transfer agent, a polymerization initiator or an iniferter, all of which have a dissociable group (or a substituent that may be derived into a dissociable group), or by ionic polymerization using a compound having a dissociable group (or a substituent that may be derived into a dissociable group) for an initiator or a terminator, may also be used.

Furthermore, suitable examples of the condensed polymer and the monomer that constitutes the condensed polymer include those described in JP-A No. 2001-247787.

—Water-Insoluble Polymer Including Constituent Unit Derived from Aromatic Group-Containing Monomer—

The self-dispersing polymer particles is preferably constituted of a water-insoluble polymer including a hydrophilic constituent unit and at least one constituent unit derived from an aromatic group-containing monomer, from the viewpoint of self-dispersibility and from the viewpoint of an enhancement of the washability of a less washable ink.

There are no particular limitations on the hydrophilic constituent unit as long as the constituent unit is derived from a hydrophilic group-containing monomer, and the constituent unit may be derived from one kind of hydrophilic group-containing monomer, or may be derived from two or more kinds of hydrophilic group-containing monomers. The hydrophilic group is not particularly limited, and the hydrophilic group may be a dissociable group or may be a nonionic hydrophilic group.

The hydrophilic group according to the invention is preferably a dissociable group, and more preferably an anionic dissociable group, from the viewpoint of the promotion of self-dispersion and from the viewpoint of the stability of the formed emulsified or dispersed state. Examples of the dissociable group include a carboxyl group, a phosphoric acid group, and a sulfonic acid group, and among them, a carboxyl group is preferred from the viewpoint of fixability when an ink composition is formed.

The hydrophilic group-containing monomer is preferably a dissociable group-containing monomer from the viewpoint of self-dispersibility and aggregatability, and a dissociable group-containing monomer having a dissociable group and an ethylenically unsaturated bond is preferred.

Examples of the dissociable group-containing monomer include an unsaturated carboxylic acid monomer, an unsaturated sulfonic acid monomer, and an unsaturated phosphoric acid monomer.

Specific examples of the unsaturated carboxylic acid monomer include acrylic acid, methacrylic acid, crotonic acid, itaconic acid, maleic acid, fumaric acid, citraconic acid, and 2-methacryloyloxymethylsuccinic acid. Specific examples of the unsaturated sulfonic acid monomer include styrenesulfonic acid, 2-acrylamido-2-methylpropanesulfonic acid, 3-sulfopropyl (meth)acrylate, and bis-(3-sulfopropyl)-itaconic acid ester. Specific examples of the unsaturated phosphoric acid monomer include vinylphosphonic acid, vinyl phosphate, bis(methcryloxyethyl)phosphate, diphenyl-2-acryloyloxyethyl phosphate, diphenyl-2-methacryloyloxyethyl phosphate, and dibutyl-2-acryloyloxyethyl phosphate.

Among the dissociable group-containing monomers, an unsaturated carboxylic acid monomer is preferred, and acrylic acid and methacrylic acid are more preferred, from the viewpoint of dispersion stability and ejection stability.

From the viewpoint of self-dispersibility, and in the case of imaging by bringing the ink into contact with an acidic treatment liquid and accelerating a aggregation reaction, from the viewpoint of the aggregation speed, the water-insoluble polymer is preferably a polymer having a carboxyl group, and more preferably a polymer having a carboxyl group and an acid value of 25 to 100 mg KOH/g. In addition, the acid value is more preferably 25 to 80 mg KOH/g, and even more preferably 30 to 65 mg KOH/g, from the viewpoint of self-dispersibility and the aggregation speed when the ink is brought into contact with a treatment liquid.

There are no particular limitations on the aromatic group-containing monomer as long as the monomer is a compound containing an aromatic group and a polymerizable group. The aromatic group may be a group derived from an aromatic hydrocarbon, or may be a group derived from an aromatic heterocyclic ring. According to the invention, the aromatic group is preferably an aromatic group derived from an aromatic hydrocarbon, from the viewpoint of the particle shape stability in an aqueous medium.

The polymerizable group may be a polymerizable group capable of polycondensation reaction, or may be a polymerizable group capable of addition polymerization. According to the invention, from the viewpoint of the particle shape stability in an aqueous medium, a polymerizable group capable of addition polymerization is preferred, and a group containing an ethylenically unsaturated bond is more preferred.

The aromatic group-containing monomer is preferably a monomer having an aromatic group derived from an aromatic hydrocarbon and an ethylenically unsaturated bond. The aromatic group-containing monomer may be used singly, or two or more kinds of aromatic group-containing monomers may be used in combination.

Examples of the aromatic group-containing monomer include phenoxyethyl (meth)acrylate, benzyl (meth)acrylate, phenyl (meth)acrylate, and styrene-based monomers. Among them, from the viewpoint of the balance between hydrophilicity and hydrophobicity of the polymer chain, and from the viewpoint of ink fixability, an aromatic group-containing (meth)acrylate monomer is preferred, and at least one selected from phenoxyethyl (meth)acrylate, benzyl (meth)acrylate, and phenyl (meth)acrylate is more preferred, while phenoxyethyl (meth)acrylate and benzyl (meth)acrylate are even more preferred.

Here, the expression “(meth)acrylate” means acrylate or methacrylate.

The content of the constituent unit derived from aromatic group-containing (meth)acrylate contained in the self-dispersing polymer particles is preferably from 10% by mass to 95% by mass. When the content of the aromatic group-containing (meth)acrylate is from 10% by mass to 95% by mass, the stability in a self-emulsified or dispersed state is enhanced, and further an increase in the ink viscosity may be suppressed.

According to the invention, from the viewpoint of the stability in a self-dispersed state, stabilization of the particle shape in an aqueous medium under the hydrophobic interaction between aromatic rings or between alicyclic rings, and a decrease in the amount of water-soluble components due to appropriate hydrophobization of the particles, and from the viewpoint of washing effects, the content of the aromatic group-containing (meth)acrylate is more preferably from 15% by mass to 90% by mass, even more preferably from 15% by mass to 80% by mass, and particularly preferably from 25% by mass to 70% by mass.

The water-insoluble polymer may be constructed using, for example, a constituent unit derived from an aromatic group-containing monomer and a constituent unit derived from a dissociable group-containing monomer. Furthermore, the water-insoluble polymer may further include another constituent unit as necessary.

There are no particular limitations on the monomer that forms the other constituent unit, as long as the monomer is copolymerizable with the aromatic group-containing monomer and the dissociable group-containing monomer. Among others, an alkyl group-containing monomer is preferred from the viewpoint of the flexibility of the polymer skeleton or the ease of control of the glass transition temperature (Tg).

Examples of the alkyl group-containing monomer include an alkyl (meth)acrylate such as methyl (meth)acrylate, ethyl (meth)acrylate, isopropyl (meth)acrylate, n-propyl (meth)acrylate, n-butyl (meth)acrylate, isobutyl (meth)acrylate, t-butyl (meth)acrylate, hexyl (meth)acrylate, or ethylhexyl (meth)acrylate; an ethylenically unsaturated monomer having a hydroxyl group, such as hydroxymethyl (meth)acrylate, 2-hydroxyethyl (meth)acrylate, 2-hydroxypropyl (meth)acrylate, 4-hydroxybutyl (meth)acrylate, hydroxypentyl (meth)acrylate, or hydroxyhexyl (meth)acrylate; a dialkylaminoalkyl (meth)acrylate such as dimethylaminoethyl (meth)acrylate; an N-hydroxyalkyl (meth)acrylamide such as N-hydroxymethyl (meth)acrylamide, N-hydroxyethyl (meth)acrylamide, or N-hydroxybutyl (meth)acrylamide; and an N-alkoxyalkyl (meth)acrylamide such as N-methoxymethyl (meth)acrylamide, N-ethoxymethyl (meth)acrylamide, N-(n-, iso-)butoxymethyl (meth)acrylamide, N-methoxyethyl (meth)acrylamide, N-ethoxyethyl (meth)acrylamide, or N-(n-, iso-)butoxyethyl (meth)acrylamide.

The molecular weight of the water-insoluble polymer is, in terms of weight average molecular weight, preferably in the range of from 3000 to 200,000, more preferably in the range of from 5000 to 150,000, and even more preferably in the range of from 10,000 to 100,000. When the weight average molecular weight is 3000 or greater, the amount of water-soluble components may be effectively suppressed, and when the weight average molecular weight is 200,000 or less, stabilization of self-dispersibility may be enhanced.

The weight average molecular weight is measured by gel permeation chromatography (GPC). GPC is carried out by using HLC-8020GPC (trade name, manufactured by Tosoh Corp.), using TSKGEL SUPER MULTIPORE HZ-H (trade name, manufactured by Tosoh Corp., 4.6 mm ID×15 cm) columns, with three columns being connected in series, and using tetrahydrofuran (THF) as an eluent. GPC is carried out under the conditions of a sample concentration of 0.35% by mass, a flow rate of 0.35 mL/min, a sample injection amount of 10 μL, and a measurement temperature of 40° C., using an IR detector. The calibration curve is produced using “standard sample TSK standard polystyrene” manufactured by Tosoh Corp., including eight samples of “F-40,” “F-20,” “F-4,” “F-1,” “A-5000,” “A-2500,” “A-1000,” and “n-propylbenzene.”

It is preferable, from the viewpoint of controlling the hydrophilicity and hydrophobicity of the polymer, that the water-insoluble polymer include a structural unit derived from an aromatic group-containing (meth)acrylate (preferably, a structural unit derived from phenoxyethyl (meth)acrylate and/or a structural unit derived from benzyl (meth)acrylate), at a copolymerization proportion of from 15% by mass to 80% by mass relative to the total mass of the self-dispersing polymer particles.

Furthermore, from the viewpoint of controlling the hydrophilicity and hydrophobicity of the polymer, the water-insoluble polymer preferably includes a constituent unit derived from an aromatic group-containing (meth)acrylate at a copolymerization proportion of from 15% by mass to 80% by mass, a constituent unit derived from a carboxyl group-containing monomer, and a constituent unit derived from an alkyl group-containing monomer (preferably, a structural unit derived from an alkyl ester of (meth)acrylic acid); and more preferably includes a structural unit derived from phenoxyethyl (meth)acrylate and/or a structural unit derived from benzyl (meth)acrylate at a copolymerization proportion of from 15% by mass to 80% by mass, a constituent unit derived from a carboxyl group-containing monomer, and a constituent unit derived from an alkyl group-containing monomer (preferably, a structural unit derived from a C₁₋₄ alkyl ester of (meth)acrylic acid). In addition, the water-insoluble polymer preferably has an acid value of 25 to 100 mg KOH/g and a weight average molecular weight of 3000 to 200,000; and more preferably has an acid value of 25 to 95 mg KOH/g and a weight average molecular weight of 5000 to 150,000.

Specific examples of the water-insoluble polymer (exemplary compounds B-01 to B-20) will be listed below. However, the invention is not intended to be limited to these. The numbers in the parentheses represent the mass ratio of the copolymerized components.
B-01: Phenoxyethyl acrylate/methyl methacrylate/acrylic acid copolymer (50/45/5)
B-02: Phenoxyethyl acrylate/methyl methacrylate/benzyl acrylate/acrylic acid copolymer (30/50/15/5)
B-03: Phenoxyethyl acrylate/benzyl methacrylate/isobutyl methacrylate/methacrylic acid copolymer (30/35/29/6)
B-04: Phenoxyethyl methacrylate/isobutyl methacrylate/methacrylic acid copolymer (50/44/6)
B-05: Phenoxyethyl acrylate/methyl methacrylate/ethyl acrylate/acrylic acid copolymer (30/55/10/5)
B-06: Benzyl methacrylate/isobutyl methacrylate/methacrylic acid copolymer (35/59/6)
B-07: Styrene/phenoxyethyl acrylate/methyl methacrylate/acrylic acid copolymer (10/50/35/5)
B-08: Benzyl acrylate/methyl methacrylate/acrylic acid copolymer (55/40/5)
B-09: Phenoxyethyl methacrylate/benzyl acrylate/methacrylic acid copolymer (45/47/8)
B-10: Styrene/phenoxyethyl acrylate/butyl methacrylate/acrylic acid copolymer (5/48/40/7)
B-11: Benzyl methacrylate/isobutyl methacrylate/cyclohexyl methacrylate/methacrylic acid copolymer (35/30/30/5)
B-12: Phenoxyethyl acrylate/methyl methacrylate/butyl acrylate/methacrylic acid copolymer (12/50/30/8)
B-13: Benzyl acrylate/isobutyl methacrylate/acrylic acid copolymer (93/2/5)
B-14: Styrene/phenoxyethyl methacrylate/butyl acrylate/acrylic acid copolymer (50/5/20/25)
B-15: Styrene/butyl acrylate/acrylic acid copolymer (62/35/3)
B-16: Methyl methacrylate/phenoxyethyl acrylate/acrylic acid copolymer (45/51/4)
B-17: Methyl methacrylate/phenoxyethyl acrylate/acrylic acid copolymer (45/49/6)
B-18: Methyl methacrylate/phenoxyethyl acrylate/acrylic acid copolymer (45/48/7)
B-19: Methyl methacrylate/phenoxyethyl acrylate/acrylic acid copolymer (45/47/8)
B-20: Methyl methacrylate/phenoxyethyl acrylate/acrylic acid copolymer (45/45/10)

—Water-Insoluble Polymer Including Constituent Unit Derived from (Meth)Acrylic Monomer Having Cyclic Aliphatic Group—

It is also preferable that the self-dispersing polymer particles be composed of a water-insoluble polymer including the hydrophilic constituent unit described above and at least one constituent unit derived from a (meth)acrylic monomer having a cyclic aliphatic group, from the viewpoint of the fixability and anti-blocking properties of the images formed.

The (meth)acrylic monomer having a cyclic aliphatic group (hereinafter, may be referred to as “alicyclic (meth)acrylate”) according to the invention is a monomer having a structure which includes a (meth)acrylic acid-derived structural moiety and an alcohol-derived structural moiety, and contains at least one unsubstituted or substituted cyclic aliphatic group in the alcohol-derived structural moiety. Furthermore, the cyclic aliphatic group may be the alcohol-derived structural moiety itself, or may be linked to the alcohol-derived structural moiety via a linking group.

In addition, the expression “(meth)acrylate” means methacrylate or acrylate.

There are no particular limitations on the cyclic aliphatic group as long as the group includes a cyclic non-aromatic hydrocarbon group, and examples of the cyclic aliphatic group include a monocyclic hydrocarbon group, a bicyclic hydrocarbon group, and a polycyclic hydrocarbon group having three or more rings.

Examples of the cyclic aliphatic group include a cycloalkyl group such as a cyclopentyl group or a cyclohexyl group; a cycloalkenyl group, a bicyclohexyl group, a norbornyl group, an isobornyl group, a dicyclopentanyl group, a dicyclopentenyl group, an adamantyl group, a decahydronaphthalenyl group, a perhydrofluorenyl group, a tricyclo[5.2.1.0^{2,6}]decanyl group, and a bicyclo[4.3.0]nonane.

The cyclic aliphatic group may further have a substituent. Examples of the substituent include an alkyl group, an alkenyl group, an aryl group, an aralkyl group, an alkoxy group, a hydroxyl group, a primary amino group, a secondary amino group, a tertiary amino group, an alkyl- or arylcarbonyl group, and a cyano group.

The cyclic aliphatic group may further form a condensed ring.

The cyclic aliphatic group according to the invention is preferably such that the cyclic aliphatic group part has 5 to 20 carbon atoms, from the viewpoint of viscosity or solubility.

Suitable examples of the linking group that links the cyclic aliphatic group with the alcohol-derived structural unit, include an alkyl group, an alkenyl group, an alkylene group, an aralkyl group, an alkoxy group, a mono- or oligoethylene glycol group, and a mono- or oligopropylene glycol group, all of which have 1 to 20 carbon atoms.

Specific examples of the alicyclic (meth)acrylate according to the invention will be listed below, but the invention is not intended to be limited to these.

Examples of monocyclic (meth)acrylate include cycloalkyl (meth)acrylates having a cycloalkyl group having 3 to 10 carbon atoms, such as cyclopropyl (meth)acrylate, cyclobutyl (meth)acrylate, cyclopentyl (meth)acrylate, cyclohexyl (meth)acrylate, cycloheptyl (meth)acrylate, cyclooctyl (meth)acrylate, cyclononyl (meth)acrylate and cyclodecyl (meth)acrylate.

Examples of bicyclic (meth)acrylate include isobornyl (meth)acrylate and norbornyl (meth)acrylate.

Examples of tricyclic (meth)acrylate include adamantyl (meth)acrylate, dicyclopentanyl (meth)acrylate, and dicyclopentenyloxyethyl (meth)acrylate.

These may be used singly or as mixtures of two or more kinds.

Among these, from the viewpoint of the dispersion stability of the self-dispersing polymer particles, fixability and anti-blocking property, it is preferable that the water-insoluble polymer include at least one bicyclic (meth)acrylate or polycyclic (meth)acrylate having three or more rings, and it is more preferable that the water-insoluble polymer include at least one selected from isobornyl (meth)acrylate, adamantyl (meth)acrylate and dicyclopentanyl (meth)acrylate.

The content ratio of the constituent unit derived from alicyclic (meth)acrylate that is contained in the self-dispersing polymer particles is preferably from 20% by mass to 90% by mass, and more preferably from 40% by mass to 90% by mass, from the viewpoint of the stability of the self-dispersed state, stabilization of the particle shape in an aqueous medium under the hydrophobic interaction between the alicyclic hydrocarbon groups, and a decrease in the amount of water-soluble components due to appropriate hydrophobization of the particles. The content ratio is particularly preferably from 50% by mass to 80% by mass.

When the proportion of the constituent unit derived from alicyclic (meth)acrylate is set at 20% by mass or greater, fixability and anti-blocking property may be ameliorated. On the other hand, when the proportion of the constituent unit derived from alicyclic (meth)acrylate is 90% by mass or less, stability of the polymer particles is enhanced.

The water-insoluble polymer may be constituted to further include another constituent unit as a hydrophobic constituent unit if necessary, in addition to the constituent unit derived from the alicyclic (meth)acrylate. There are no particular limitations on the monomer that forms the other constituent unit as long as the monomer is a monomer copolymerizable with the alicyclic (meth)acrylate and the hydrophilic group-containing monomer that will be described below, and any known monomer may be used.

Specific examples of the monomer that forms the other constituent unit (hereinafter, may be referred to as “other copolymerizable monomer”) include, for example, an alkyl (meth)acrylate such as methyl (meth)acrylate, ethyl (meth)acrylate, isopropyl (meth)acrylate, n-propyl (meth)acrylate, n-butyl (meth)acrylate, isobutyl (meth)acrylate, t-butyl (meth)acrylate, hexyl (meth)acrylate, or ethylhexyl (meth)acrylate; an aromatic ring-containing (meth)acrylate such as benzyl (meth)acrylate or phenoxyethyl (meth)acrylate; a styrene such as styrene, α-methylstyrene or chlorostyrene; a dialkylaminoalkyl (meth)acrylate such as dimethylaminoethyl (meth)acrylate; N-hydroxyalkyl (meth)acrylamide such as N-hydroxymethyl (meth)acrylamide, N-hydroxyethyl (meth)acrylamide, or N-hydroxybutyl (meth)acrylamide; and an N-alkoxyalkyl (meth)acrylamide such as N-methoxymethyl (meth)acrylamide, N-ethoxymethyl (meth)acrylamide, N-(n-, iso-)butoxymethyl (meth)acrylamide, N-methoxyethyl (meth)acrylamide, N-ethoxyethyl (meth)acrylamide, or N-(n-, iso-)butoxyethyl (meth)acrylamide.

Among them, from the viewpoint of the flexibility of the polymer skeleton or the ease of control of the glass transition temperature (Tg), and from the viewpoint of the dispersion stability of the polymer particles, the monomer that forms the other constituent unit is preferably at least one (meth)acrylate containing a chain-like alkyl group having 1 to 8 carbon atoms, more preferably a (meth)acrylate having a chain-like alkyl group having 1 to 4 carbon atoms, and particularly preferably methyl (meth)acrylate or ethyl (meth)acrylate. Here, the chain-like alkyl group refers to an alkyl group having a straight chain or a branched chain.

Furthermore, a (meth)acrylate containing an aromatic group may also be used with preference as the other copolymerizable monomer. When an aromatic-containing (meth)acrylate is included as the other copolymerizable monomer, from the viewpoint of the dispersion stability of the self-dispersing polymer particles, the proportion of the constituent unit derived from an aromatic-containing (meth)acrylate is preferably 40% by weight or less, more preferably 30% by weight or less, and particularly preferably 20% by weight or less.

Furthermore, in the case of using a styrene-based monomer as the other copolymerizable monomer, from the viewpoint of stability when the polymer is made into the self-dispersing polymer particles, the proportion of the constituent unit derived from the styrene-based monomer is preferably 20% by mass or less, more preferably 10% by mass or less, and even more preferably 5% by mass or less, and it is particularly preferable that the water-insoluble polymer do not include a constituent unit derived from a styrene-based monomer.

Here, the styrene-based monomer refers to styrene, substituted styrene (α-methylstyrene, chlorostyrene, or the like), and a styrene macromer having a polystyrene structural unit.

The other copolymerizable monomer may be used singly, or two or more kinds may be used in combination. When the polymer includes the other constituent unit, the content is preferably from 10% by mass to 80% by mass, more preferably from 15% by mass to 75% by mass, and particularly preferably from 20% by mass to 70% by mass. When two or more kinds of the monomer that forms the other constituent unit are used in combination, the total content is preferably in the range described above.

From the viewpoint of dispersion stability, the water-insoluble polymer is preferably a polymer obtainable by polymerizing at least three kinds of monomers such as an alicyclic (meth)acrylate, another copolymerizable monomer, and a hydrophilic group-containing monomer, and is more preferably a polymer obtainable by polymerizing at least three kinds of monomers such as an alicyclic (meth)acrylate, an alkyl group-containing (meth)acrylate having a linear or branched chain having 1 to 8 carbon atoms, and a hydrophilic group-containing monomer.

According to the invention, in regard to the content of the (meth)acrylate having a straight-chained or branched alkyl group having 9 or more carbon atoms, and the constituent unit having a highly hydrophobic substituent derived from an aromatic group-containing macromonomer or the like, it is preferable that the water-insoluble polymer do not substantially include the (meth)acrylate and the constituent unit, and it is more preferable that the water-insoluble polymer do not include any of the (meth)acrylate and the constituent unit, from the viewpoint of dispersion stability.

The molecular weight of the water-insoluble polymer is, in terms of weight average molecular weight, preferably in the range of 3000 to 200,000, more preferably in the range of 10,000 to 200,000, and even more preferably in the range of 30,000 to 150,000. When the weight average molecular weight is 3000 or greater, the amount of water-soluble components may be effectively suppressed. Furthermore, when the weight average molecular weight is 200,000 or less, self-dispersion stability may be increased.

The glass transition temperature (Tg) of the self-dispersing polymer particles is preferably 40° C. to 180° C., more preferably 60° C. to 170° C., and particularly preferably 70° C. to 150° C. When the glass transition temperature is 40° C. or higher, the scratch resistance or the anti-blocking property of the images formed by using the inkjet ink composition is further improved. Furthermore, the glass transition temperature is 180° C. or lower, the scratch resistance of images is further improved.

From the viewpoint of controlling the hydrophilicity and hydrophobicity of the polymer, the water-insoluble polymer is preferably a vinyl polymer which includes from 20% by mass to 90% by mass as a copolymerization proportion of a structure derived from an alicyclic (meth)acrylate, and at least one of a structure derived from a dissociable group-containing monomer and a structure derived from a (meth)acrylate containing a chain-like alkyl group having 1 to 8 carbon atoms, and which has an acid value of 20 to 120, a total content of the hydrophilic structural unit of 25% by mass or less, and a weight average molecular weight of 3000 to 200,000.

Furthermore, the water-insoluble polymer is more preferably a vinyl polymer which includes 30% by mass or more and less than 90% by mass as a copolymerization proportion of a structure derived from a bicyclic (meth)acrylate or a polycyclic (meth)acrylate having three or more rings; 10% by mass or more and less than 70% by mass as a copolymerization proportion of a structure derived from a (meth)acrylate containing a chain-like alkyl group having 1 to 4 carbon atoms; and a structure derived from a carboxyl group-containing monomer, the structure derived from a carboxyl group-containing monomer is included so that an acid value fall in the range of from 25 to 100, a total content of the hydrophilic structural unit of 25% by mass or less, and a weight average molecular weight of 10,000 to 200,000.

Furthermore, the water-insoluble polymer is particularly preferably a vinyl polymer which includes 40% by mass or more and less than 80% by mass as a copolymerization proportion of a structure derived from a bicyclic (meth)acrylate or a polycyclic (meth)acrylate having three or more rings; 20% by mass or more and less than 60% by mass as a copolymerization proportion of a structure derived from at least methyl (meth)acrylate or ethyl (meth)acrylate; and a structure derived from acrylic acid or methacrylic acid, the structure derived from acrylic acid or methacrylic acid is included so that an acid value fall in the range of from 30 to 80, a total content of the hydrophilic structural unit of 25% by mass or less, and a weight average molecular weight of 30,000 to 150,000.

Specific examples of the water-insoluble polymer include the following exemplary compounds C-01 to C-13, but the invention is not intended to be limited to these compounds. Furthermore, the numbers in the parentheses represent the mass ratio of the copolymerized components.
C-01: Methyl methacrylate/isobornyl methacrylate/methacrylic acid copolymer (40/52/8)
C-02: Methyl methacrylate/isobornyl methacrylate/benzyl methacrylate/methacrylic acid copolymer (30/50/14/6)
C-03: Methyl methacrylate/dicyclopentanyl methacrylate/methacrylic acid copolymer (40/50/10)
C-04: Methyl methacrylate/dicyclopentanyl methacrylate/phenoxyethyl methacrylate/methacrylic acid copolymer (30/50/14/6)
C-05: Methyl methacrylate/isobornyl methacrylate/methoxypolyethylene glycol methacrylate (n=2)/methacrylic acid copolymer (30/54/10/6)
C-06: Methyl methacrylate/dicyclopentanyl methacrylate/methoxypolyethylene glycol methacrylate (n=2)/methacrylic acid copolymer (54/35/5/6)
C-07: Methyl methacrylate/adamantly methacrylate/methoxypolyethylene glycol methacrylate (n=23)/methacrylic acid copolymer (30/50/15/5)
C-08: Methyl methacrylate/isobornyl methacrylate/dicyclopentanyl methacrylate/methacrylic acid copolymer (20/50/22/8)
C-09: Ethyl methacrylate/cyclohexyl methacrylate/acrylic acid copolymer (50/45/5)
C-10: Isobutyl methacrylate/cyclohexyl methacrylate/acrylic acid copolymer (40/50/10)
C-11: n-butyl methacrylate/cyclohexyl methacrylate/styrene/acrylic acid copolymer (30/55/10/5)
C-12: Methyl methacrylate/dicyclopentenyloxyethyl methacrylate/methacrylic acid copolymer (40/52/8)
C-13: Laurylmethacrylate/dicyclopentenyloxyethylmethacrylate/methacrylic acid copolymer (25/65/10)

There are no particular limitations on the method for producing a water-insoluble polymer that constitutes the self-dispersing polymer particles according to the invention, and examples of the method include a method of performing emulsion polymerization in the presence of a polymerizable surfactant and thereby covalently bonding the surfactant with a water-insoluble polymer; and a method of copolymerizing a monomer mixture including the hydrophilic group-containing monomer and aromatic group-containing monomer described above, by a known polymerization method such as a solution polymerization method or a bulk polymerization method. Among the polymerization methods, from the viewpoint of the aggregation speed and the droplet ejection stability when the water-insoluble polymer is prepared into an ink composition, a solution polymerization method is preferred, and a solution polymerization method using an organic solvent is more preferred.

From the viewpoint of the aggregation speed, it is preferable that the self-dispersing polymer particles be prepared as a polymer dispersion which contains a polymer synthesized in an organic solvent, the polymer having a carboxyl group (and preferably having an acid value of 20 to 100 mg KOH/g), and which has a part or all of the carboxyl groups of the polymer neutralized and has water as a continuous phase. That is, it is preferable that the preparation of the self-dispersing polymer particles according to the invention be carried out by providing a step of synthesizing a polymer in an organic solvent, and a dispersing step of forming an aqueous dispersion in which at least a part of the carboxyl groups of the polymer is neutralized.

The dispersing step preferably includes the following step (1) and step (2).

Step (1): a step of stirring a mixture containing a polymer (water-insoluble polymer), an organic solvent, a neutralizing agent, and an aqueous medium.

Step (2): a step of removing the organic solvent from the mixture.

The step (1) is preferably a treatment of first dissolving the polymer (water-insoluble polymer) in an organic solvent, subsequently slowly adding a neutralizing agent and an aqueous medium thereto, and mixing and stirring the mixture to obtain a dispersion. As such, when a neutralizing agent and an aqueous medium are added to a water-insoluble polymer solution dissolved in an organic solvent, self-dispersing polymer particles which does not require a strong shearing force and has a particle size that gives higher storage stability, may be obtained.

There are no particular limitations on the method of stirring the mixture, and a mixing and stirring apparatus that is commonly used, or if necessary, a dispersing machine such as an ultrasonic dispersing machine or a high pressure homogenizer, may be used.

Preferred examples of the organic solvent include an alcohol-based solvent, a ketone-based solvent, and an ether-based solvent.

Examples of the alcohol-based solvent include isopropyl alcohol, n-butanol, t-butanol, and ethanol. Examples of the ketone-based solvent include acetone, methyl ethyl ketone, diethyl ketone, and methyl isobutyl ketone. Examples of the ether-based solvent include dibutyl ether and dioxane. Among these solvents, a ketone-based solvent such as methyl ethyl ketone, and an alcohol-based solvent such as isopropyl alcohol are preferred. Furthermore, it is also preferable to use isopropyl alcohol and methyl ethyl ketone in combination, for the purpose of moderating the changes in polarity at the time of phase transition from an oil phase to an aqueous phase. When those solvents are used in combination, self-dispersing polymer particles which lack aggregation and precipitation or fusion between particles, and have a fine particle size with high dispersion stability, may be obtained.

The neutralizing agent is used so that a part or all of the dissociable groups are neutralized, and the self-dispersing polymer forms a stable emulsified or dispersed state in water. When the self-dispersing polymer has an anionic dissociable group (for example, a carboxyl group) as a dissociable group, examples of the neutralized agent to be used include basic compounds such as an organic amine compound, ammonia, and alkali metal hydroxides. Examples of the organic amine compound include monomethylamine, dimethylamine, trimethylamine, monoethylamine, diethylamine, triethylamine, monopropylamine, dipropylamine, monoethanolamine, diethanolamine, triethanolamine, N,N-dimethylethanolamine, N,N-diethylethanolamine, 2-dimethylamino-2-methyl-1-propanol, 2-amino-2-methyl-1-propanol, N-methyldiethanolamine, N-ethyldiethanolamine, monoisopropanolamine, diisopropanolamine, and triisopropanolamine. Examples of the alkali metal hydroxides include lithium hydroxide, sodium hydroxide, and potassium hydroxide. Among them, from the viewpoint of dispersion stabilization of the self-dispersing polymer particles in water, sodium hydroxide, potassium hydroxide, triethylamine and triethanolamine are preferred.

It is preferable to use these basic compounds in an amount of from 5% by mass to 120% by mole, more preferably from 10% by mass to 110% by mole, and even more preferably from 15% by mass to 100% by mole, relative to 100% by mole of the dissociable group. When the content of the basic compound is set at 5% by mole or greater, 10% by mole or greater, and particularly 15% by mole or greater, an effect of stabilizing the dispersion of particles in water is manifested, and when the content of the basic compound is set at 120% by mole or less, 110% by mole or less, and particularly 100% by mole or less, an effect of reducing water-soluble components is manifested.

In the step (2), an aqueous dispersion of self-dispersing polymer particles may be obtained by distilling off the organic solvent from the dispersion obtained in the step (1) by a conventional method such as distillation under reduced pressure, and thereby converting the phase to an aqueous phase. The organic solvent in the aqueous dispersion thus obtained is substantially removed, and the amount of the organic solvent in the aqueous dispersion is preferably 0.2% by mass or less, and more preferably 0.1% by mass or less.

The average particle size of the polymer particles (particularly, self-dispersing polymer particles) is, in terms of volume average particle size, preferably in the range of from 10 to 400 nm, more preferably in the range of from 10 to 200 nm, even more preferably in the range of from 10 to 100 nm, and particularly in the range of from 10 to 50 nm. When the average particle size is 10 nm or greater, production suitability is enhanced. Furthermore, when the average particle size is 400 nm or less, storage stability is enhanced. There are no particular limitations on the particle size distribution of the polymer particles, and any of polymer particles having a broad particle size distribution or polymer particles having a monodisperse particle size distribution may be used. Furthermore, two or more kinds of water-insoluble particles may be used in mixture.

The volume average particle size and particle size distribution of the polymer particles are values determined by making measurements by a dynamic light scattering method using a NanoTrac particle size distribution analyzer (trade name: UPA-EX150, manufactured by Nikkiso Co., Ltd.).

The content of the polymer particles (particularly, self-dispersing polymer particles) in the ink composition is preferably from 1% by mass to 30% by mass, and more preferably from 2% by mass to 15% by mass, relative to the total mass of the ink composition, from the viewpoint of scratch resistance and glossiness of the images. The polymer particles (particularly, self-dispersing polymer particles) are such that a single kind may be used alone, or two or more kinds may be used in mixture.

[Hydrophilic Organic Solvent]

The ink according to the invention includes water as a solvent, and preferably includes at least one hydrophilic organic solvent. When the ink contains a hydrophilic organic solvent, prevention of drying and acceleration of penetration may be promoted. When the hydrophilic organic solvent is used as a drying preventing agent, clogging of nozzles that may occur as a result of the drying of the ink at the ink ejection nozzles during the recording of images by ejecting the ink by an inkjet method, may be effectively prevented.

For the purpose of preventing dryness, a hydrophilic organic solvent having a lower vapor pressure than water is preferred. Specific examples of the hydrophilic organic solvent that is suitable for the prevention of drying, include polyhydric alcohols represented by ethylene glycol, propylene glycol, diethylene glycol, polyethylene glycol, thiodiglycol, dithiodiglycol, 2-methyl-1,3-propanediol, 1,2,6-hexanetriol, acetylene glycol derivatives, glycerin, and trimethylolpropane; lower alkyl ethers of polyhydric alcohols, such as ethylene glycol monomethyl (or ethyl)ether, diethylene glycol monomethyl (or ethyl)ether, and triethylene glycol monoethyl (or butyl)ether; heterocyclic rings such as 2-pyrrolidone, N-methyl-2-pyrrolidone, 1,3-dimethyl-2-imidazolidinone, and N-ethylmorpholine; sulfur-containing compounds such as sulfolane, dimethyl sulfoxide and 3-sulfolene; polyfunctional compounds such as diacetone alcohol and diethanolamine; and urea derivatives.

Among them, polyhydric alcohols such as glycerin and diethylene glycol are preferred. Furthermore, these organic solvents may be used singly or in combination of two or more kinds. It is preferable that these hydrophilic organic solvents be contained in the ink composition at a proportion of from 10% by mass to 50% by mass.

Furthermore, for the purpose of accelerating penetration, a hydrophilic organic solvent is suitably used from the viewpoint of allowing thorough penetration of the ink composition into a recording medium. Specific examples of the hydrophilic organic solvent that is suitable for the acceleration of penetration, include alcohols such as ethanol, isopropanol, butanol, di(tri)ethylene glycol monobutyl ether, and 1,2-hexanediol. When these organic solvents are contained in the ink composition at a proportion of 5% by mass to 30% by mass, satisfactory effects may be obtained. Furthermore, it is preferable that these hydrophilic organic solvents be used in an amount of addition that does not cause bleeding of print and images, and print-through.

In addition to the purposes described above, the hydrophilic organic solvent may be used in the adjustment of viscosity. Specific examples of the hydrophilic organic solvent that may be used in the adjustment of viscosity, include alcohols (for example, methanol, ethanol, propanol, isopropanol, butanol, isobutanol, sec-butanol, t-butanol, pentanol, hexanol, cyclohexanol, and benzyl alcohol), polyhydric alcohols (for example, ethylene glycol, diethylene glycol, triethylene glycol, tetraethylene glycol, polyethylene glycol, propylene glycol, dipropylene glycol, tripropylene glycol, polypropylene glycol, butylene glycol, trimethylolpropane, hexanediol, pentanediol, glycerin, hexanetriol, and thiodigylcol), glycol derivatives (for example, ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethyl ether acetate, triethylene glycol monomethyl ether, triethylene glycol monoethyl ether, and ethylene glycol monophenyl ether), amines (for example, ethanolamine, diethanolamine, triethanolamine, N-methyldiethanolamine, N-ethyldiethanolamine, morpholine, N-ethylmorpholine, ethylenediamine, diethylenetriamine, triethylenetetramine, polyethyleneimine, and tetramethylpropylenediamine), and other polar solvents (for example, formamide, N,N-dimethylformamide, N,N-dimethylacetamide, dimethylsulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile, and acetone).

The hydrophilic organic solvents may be used singly, or two or more kinds may be used in mixture.

[Surfactant]

The ink according to the invention preferably contains at least one surfactant. The surfactant is used as a surface tension adjusting agent. Examples of the surface tension adjusting agent include a nonionic surfactant, a cationic surfactant, an anionic surfactant, and a betaine surfactant.

It is preferable that the surfactant be contained in an amount capable of adjusting the surface tension of the ink composition to 20 to 60 mN/m, so that droplet ejection may be satisfactorily achieved by an inkjet method. Among others, the content of the surfactant is preferably an amount capable of adjusting the surface tension to 20 to 45 mN/m, and more preferably an amount capable of adjusting the surface tension to 25 to 40 mN/m.

The surface tension of the ink composition is measured by a plate method under the conditions of 25° C., using an automatic surface tensiometer (trade name: CBVP-Z, manufactured by Kyowa Interface Science Co., Ltd.).

Specific preferable examples of the surfactant include, as hydrocarbons, anionic surfactants such as a fatty acid salt, an alkylsulfate ester, an alkyl benzenesulfonate, an alkyl naphthalenesulfonate, a dialkyl sulfosuccinate, an alkyl phosphate ester, a naphthalenesulfonic acid-formalin condensate, and a polyoxyethylene alkylsulfate ester; and nonionic surfactants such as a polyoxyethylene alkyl ether, a polyoxyethylene alkyl aryl ether, a polyoxyethylene fatty acid ester, a sorbitan fatty acid ester, a polyoxyethylene sorbitan fatty acid ester, a polyoxyethylene alkylamine, a glycerin fatty acid ester, and an oxyethylene-oxypropylene block copolymer. Furthermore, ORFINS (trade name, manufactured by Nissin Chemical Co., Ltd.) and SURFYNOLS (trade name, manufactured by Air Products & Chemicals, Inc.), which are acetylene-based polyoxyethylene oxide surfactants, are also used with preference. An amine oxide type amphoteric surfactant such as N,N-dimethyl-N-alkylamine oxide is also preferred.

In addition, the surfactants described in pages (37) to (38) of JP-A No. 59-157636 and Research Disclosure No. 308119 (1989) may also be used.

The fluorine-based (fluoroalkyl-based) surfactants, silicone-based surfactants and the like described in JP-A No. 2003-322926, JP-A No. 2004-325707 and JP-A No. 2004-309806 may also be used, and scratch resistance may be ameliorated.

These surface tension adjusting agents may also be used as defoamants, and a fluorine-based compound, a silicone-based compound, and a chelating agent represented by EDTA may also be used.

[Water]

The ink according to the invention preferably contains water. Furthermore, there are no particular limitations on the amount of water contained in the ink. A preferred content of water in the invention is 10% by mass to 99% by mass, more preferably 30% by mass to 80% by mass, and even more preferably 50% by mass to 70% by mass.

[Other Additives]

The ink according to the invention may further contain other additives in addition to the components described above. Examples of the other additives include known additives such as a discoloration preventing agent, an emulsification stabilizer, a penetration promoting agent, an ultraviolet absorbing agent, an antiseptic agent, an antifungal agent, a pH adjusting agent, a defoaming agent, a viscosity adjusting agent, a dispersant, a dispersion stabilizer, an antirust agent and a chelating agent. These various additives may be added directly after the preparation of the aqueous ink composition, or may be added during the preparation of the aqueous ink composition.

As the pH adjusting agent, a neutralizing agent (organic base or inorganic alkali) may be used. In regard to the pH adjusting agent, from the viewpoint of enhancing the storage stability of the aqueous ink composition, the pH adjusting agent is preferably added so that the pH of the aqueous ink composition reaches 6 to 10, and more preferably so that the pH reaches 7 to 10. The pH is measured under the conditions of 25° C.

The viscosity of the aqueous ink composition according to the invention is preferably in the range of 1 to 30 mPa·s, more preferably in the range of 1 to 20 mPa·s, even more preferably in the range of 2 to 15 mPa·s, and particularly preferably in the range of 2 to 10 mPa·s, from the viewpoint of ejection stability in the case of performing ejection by an inkjet method, and from the viewpoint of the aggregation speed obtainable when the treatment liquid that will be described below is used.

The viscosity is a value obtained by measuring an aqueous ink composition under the conditions of 20° C. by using a viscometer (trade name: TV-22, manufactured by Toki Sangyo Co., Ltd.).

<<Image Forming Method>>

The image forming method of the invention utilizes the ink set of the invention, and also includes a treatment liquid applying step of applying a treatment liquid onto a recording medium, and an ink applying step of recording an image by applying an ink onto the recording medium by an inkjet method.

The image forming method of the invention having such a constitution is capable of increasing the speed of image formation, and allows the occurrence of gloss unevenness in the image areas.

The image forming method of the invention may further have other steps as necessary. An example of the other steps may be a heating and fixing step of heating an ink image formed by applying an ink, and fixing the ink image to the recording medium.

<Treatment Liquid Applying Step>

The treatment liquid applying step according to the invention is carried out by applying a treatment liquid onto a recording medium. The details of the composition and preferred aspects of the treatment liquid used in the present step are as described above.

Application of the treatment liquid may be carried out by applying a known method such as a coating method, an inkjet method or an immersion method. The coating method may be carried out according to known coating methods using a bar coater, an extrusion die coater, an air doctor coater, a blade coater, a rod coater, a knife coater, a squeeze coater, a reverse roll coater, a bar coater and the like. The details of the inkjet method will be discussed in the ink applying step that will be described below.

The treatment liquid applying step may be provided before or after the ink applying step that will be described below. According to the invention, an aspect of providing the ink applying step after the treatment liquid applying step is preferred. That is, according to a preferred aspect, a treatment liquid for preliminarily aggregating the coloring material (preferably, pigment) in the ink is applied onto a recording medium before the ink is applied, and imaging is carried out by applying the ink so that the ink is brought into contact with the treatment liquid applied onto the recording medium. Thereby, image formation may be accelerated, and images having high density and high resolution may be obtained even if the speed of image formation is increased.

There are no particular limitations on the amount of application of the treatment liquid as long as the treatment liquid is capable of aggregating the ink, but preferably, the amount of application of the treatment liquid may be adjusted to an amount capable of achieving an amount of application of the aggregating components of 0.1 g/m² or greater. Inter alia, the amount of application of the treatment liquid is preferably an amount capable of achieving an amount of application of the aggregating components of 0.1 to 1.0 g/m², and more preferably 0.2 to 0.8 g/m². When the amount of application of the aggregating components is 0.1 g/m² or greater, the aggregation reaction proceeds satisfactorily, and when the amount of application of the aggregating components is 1.0 g/m² or less, the degree of glossiness is not excessively increased, which is preferable.

Here, the amount of application of the aggregating components is the amount of application combining the first aggregating agent and the second aggregating agent.

According to the invention, it is preferable to provide an ink applying step after the treatment liquid applying step, and after the treatment liquid is applied onto a recording medium and before an ink is applied thereon, to further provide a heating and drying step of heating and drying the treatment liquid on the recording medium. When the treatment liquid is heated and dried in advance before the ink applying step, ink colorability such as the prevention of bleeding is improved, and visible images having satisfactory color density and satisfactory color phase may be recorded.

The heating and drying process may be carried out by means of a known heating unit such as a heater, an air blowing unit utilizing air blowing, such as a dryer, or a unit combining these. Examples of the heating method include a method of providing heat with a heater or the like from the opposite surface of the recording medium where the treatment liquid is applied; a method of blowing warm air or hot air to the surface of the recording medium where the treatment liquid is applied; and a method of heating using an infrared heater, and plural kinds of these heating methods may be used in combination.

<Ink Applying Step>

The ink applying step according to the invention is carried out by recording an image by applying an ink onto a recording medium by an inkjet method. The details of the composition and preferred aspects of the ink used in the present step are as described above.

There are no particular limitations on the inkjet method, and any known system may be employed, for example, a charge control system that ejects ink by utilizing an electrostatic attraction force; a drop-on-demand system that utilizes the vibration pressure of a piezoelectric element (pressure pulse system); an acoustic inkjet system that converts electric signals into acoustic beams, irradiates ink with the beams, and ejects the ink by utilizing a radiation pressure; and a thermal inkjet (BUBBLEJET (registered trademark)) system that heats ink to form bubbles and utilizes the pressure resulting therefrom.

Furthermore, the inkjet method described above includes the usage of a system that injects a large number of small-volume droplets of a low-concentration ink called photo-ink; a system that improves the image quality by using plural kinds of inks having a substantially identical color phase but different concentrations; and a system that makes use of a colorless transparent ink.

In addition, there are no particular limitations on the ink nozzle that is used when recording is performed by an inkjet method, and the ink nozzle may be appropriately selected according to the purpose.

Furthermore, the inkjet method may employ a shuttle system in which a short serial head is used, and recording is performed while the head is allowed to move in a scanning manner along the width direction of the recording medium; as well as a line system that makes use of a line head in which recording elements are arranged to face the entire length of one side of the recording medium. In the line system, image recording may be performed over the entire surface of the recording medium by scanning the recording medium in the direction perpendicular to the direction in which the recording elements are arranged. Furthermore, since only the recording medium is made to move, an improvement of the recording speed may be realized, as compared with the shuttle system.

The amount of liquid droplets that are ejected from the inkjet head is preferably 0.2 to 10 picoliters (pl), and more preferably 0.4 to 5 pl.

Furthermore, the maximum total amount of ejection of the ink during the image recording process is preferably in the range of 10 to 36 mL/m², and more preferably in the range of 15 to 30 mL/m².

Furthermore, according to the invention, it is preferable to further provide a step of heating and drying the ink on the recording medium after the ink applying step. By heating and drying the ink after the ink applying step, the aggregation speed of the ink may be increased. Heating and drying of the ink may be carried out by a unit similar to the step of heating and drying the treatment liquid.

<Heating and Fixing Step>

The heating and fixing step is carried out by heating the image recorded by applying an ink and thereby fixing the image to the recording medium. When an image is subjected to the heating and fixing treatment, fixing of the image onto the recording medium is achieved, and the scratch resistance of the image may be further enhanced. Therefore, it is preferable to provide the heating and fixing step in the image forming method of the invention.

Heating is preferably carried out at or above the minimum film forming temperature (MFT) of the polymer particles in the image. When the polymer particles are heated at or above the MFT, the polymer particles are formed into a film, and the image is strengthened.

The pressure employed during the process of applying pressure together with heating, is preferably in the range of 0.1 to 3.0 MPa, more preferably in the range of 0.1 to 1.0 MPa, and even more preferably in the range of 0.1 to 0.5 MPa, in view of surface smoothening.

There are no particularly limitations on the method of heating, but suitable examples include methods of drying in a non-contacting manner, such as a method of heating with a heating body such as a nichrome wire heater, a method of supplying warm air or hot air, and a method of heating with a halogen lamp, an infrared lamp or the like. Furthermore, there are no particular limitations on the method of hot pressing, but suitable examples include a method of carrying out heating and fixing by contacting, such as a method of pressing a hot plate to the surface of the recording medium where an image is formed; and a method of passing an image between a pair of hot pressing rollers, between a pair of hot pressing belts, or between a pair of rollers using a hot pressing apparatus that is equipped with a hot pressing belt disposed on the image-recorded surface side of the recording medium, and a retaining roller disposed on the other side of the hot pressing belt.

In the case of hot pressing, the nip time is preferably 1 millisecond to 10 seconds, more preferably 2 milliseconds to 1 second, and more preferably 4 milliseconds to 100 milliseconds. Furthermore, the nip width is preferably 0.1 mm to 100 mm, more preferably 0.5 mm to 50 mm, and more preferably 1 mm to 10 mm.

The hot pressing roller may be a metallic roller made of a metal, or may be a roller having a core made of a metal, and coating layer formed from an elastic body and, if necessary, a surface layer (also called as releasable layer) provided around the metal core. The metal core of the latter may be composed of, for example, a cylinder made of iron, aluminum or SUS, while the surface of the metal core is preferably at least partially covered with the coating layer. Particularly, the coating layer is preferably formed from a silicone resin or a fluororesin, which has mold releasability. It is also preferable that the metal core in one of the hot pressing rollers have a heating body mounted inside, and the recording medium may be heated by passing the recording medium between rollers, by simultaneously subjecting the recording medium to a heat treatment and a pressing treatment, or if necessary, by placing the recording medium between two heating rollers. Preferable examples of the heating body include a halogen lamp heater, a ceramic heater, and a nichrome wire.

The belt substrate that constitutes the hot pressing belt used in the hot pressing apparatus is preferably seamless nickel-plated brass, and the thickness of the substrate is preferably 10 to 100 μm. As the material of the belt substrate, aluminum, iron, polyethylene and the like may also be used in addition to nickel. When a silicone resin or a fluororesin is provided, the thickness of the layer formed by using these resins is preferably 1 to 50 μm, and more preferably 10 to 30 μm.

Furthermore, in order to achieve the aforementioned pressure (nip pressure), for example, an elastic member such as a spring having tension may be selected and installed at both ends of the roller such as the hot pressing roller, with the nip interval taken into consideration, so as to obtain a desired nip pressure.

The conveying speed of the recording medium in the case of using a hot pressing roller or a hot pressing belt, is preferably 200 to 700 mm/seconds, more preferably 300 to 650 mm/seconds, and even more preferably 400 to 600 mm/seconds.

[Recording Medium]

The image forming method of the invention is intended to form an image on a recording medium.

There are no limitations on the recording medium to be used, but a so-called coated paper, which is used in general offset printing or the like, is suitable. The coated paper is a paper produced by providing a coating layer containing an inorganic pigment or the like, on the surface of high quality paper or neutral paper serving as a support, which is mainly composed of cellulose and is generally non-surface-treated. Coated papers are prone to have gloss unevenness in the image areas, but according to the image forming method of the invention, the occurrence of gloss unevenness in the image areas may be effectively suppressed. Specifically, art paper, coated paper, lightweight coated paper, or finely coated paper is preferred.

There are no particular limitations on the inorganic pigment that is contained in the coating layer, but from the viewpoint that the effect of suppressing the occurrence of gloss unevenness in the image areas is more notably exhibited, at least one selected from silica, kaolin, clay, calcined clay, zinc oxide, tin oxide, magnesium sulfate, aluminum oxide, aluminum hydroxide, pseudo-boehmite, calcium carbonate, satin white, aluminum silicate, smectite, zeolite, magnesium silicate, magnesium carbonate, magnesium oxide, and diatomaceous earth is preferred. Among them, calcium carbonate, silica and kaolin are preferred, and calcium carbonate is particularly preferred.

In regard to the recording medium, generally any recording medium that is commercially available may be used, and examples include high quality paper (A) such as “OK PRINCE HIGH QUALITY” (trade name, manufactured by Oji Paper Co., Ltd.), “SHIRAOI” (trade name, manufactured by Nippon Paper Group, Inc.), and “NEW NPI HIGH QUALITY” (trade name, manufactured by Nippon Paper Group, Inc.); finely coated paper such as “OK EVER LIGHT COAT” (trade name, manufactured by Oji Paper Co., Ltd.) and “AURORA S” (trade name, manufactured by Nippon Paper Group, Inc.); lightweight coated paper (A3) such as “OK COAT L” (trade name, manufactured by Oji Paper Co., Ltd.) and “AURORA L” (trade name, manufactured by Nippon Paper Group, Inc.); coated paper (A2, B2) such as “OK TOPCOAT+” (trade name, manufactured by Oji Paper Co., Ltd.) and “AURORA COAT” and “N SILVER DIA” (trade name, manufactured by Nippon Paper Group, Inc.); and art paper (A1) such as “OK KINFUJI+” (trade name, manufactured by Oji Paper Co., Ltd.) and “TOKUBISHI ART” (trade name, manufactured by Mitsubishi Paper Mills, Ltd.). Various papers exclusive for photographic use may also be used for the purpose of inkjet recording.

Exemplary aspects of the invention will be listed below.

<1> An ink set comprising an ink containing at least a coloring material, and a treatment liquid including at least one first aggregating agent selected from the following group (A) and at least one second aggregating agent selected from the following group (B), which is different from the group (A):

(A) orthophosphoric acid, phosphorous acid, hypophosphorous acid, pyrophosphoric acid, tartaric acid and salts thereof; and

(B) an organic acid having a first dissociation constant pKa of 3.2 or less, or a salt thereof (b-1), an inorganic acid or a salt thereof (b-2), and a polyvalent metal salt (b-3).

<2> The ink set according to item <1>, wherein the mass ratio of the first aggregating agent to the second aggregating agent in the treatment liquid is from 1:9 to 9:1.

<3> The ink set according to item <1> or <2>, wherein the treatment liquid contains a hydrophilic organic solvent.

<4> The ink set according to any one of items <1> to <3>, wherein the coloring material is a pigment.

<5> The ink set according to item <4>, wherein the pigment is a pigment coated with a polymeric dispersant.

<6> The ink set according to any one of items <1> to <5>, wherein the ink contains polymer particles.

<7> The ink set according to item <6>, wherein the polymer particles are self-dispersing polymer particles.

<8> An image forming method comprising applying a treatment liquid on a recording medium, and applying an ink on the recording medium by an inkjet method and thereby recording an image, wherein the method uses the ink set of any one of <1> to <7>.

<9> The image forming method according to item <8>, further comprising heating the image recorded by applying the ink, and thereby fixing the image to the recording medium.

<10> The image forming method according to item <9>, wherein the recording medium is a recording medium having a support and a coating layer containing an inorganic pigment.

<11> The image forming method according to item <10>, wherein the inorganic pigment is at least one of silica, kaolin, clay, calcined clay, zinc oxide, tin oxide, magnesium sulfate, aluminum oxide, aluminum hydroxide, pseudo-boehmite, calcium carbonate, satin white, aluminum silicate, smectite, zeolite, magnesium silicate, magnesium carbonate, magnesium oxide, or diatomaceous earth.

### EXAMPLES

Hereinafter, the invention will be described in more detail by way of Examples, but the invention is not intended to be limited to these Examples. In addition, unless particularly stated otherwise, the units “part” and “% (percentage)” are on a mass basis.

The weight average molecular weight was measured by gel permeation chromatography (GPC). GPC was carried out using HLC-8020GPC (trade name, manufactured by Tosoh Corp.), using three TSKGEL SUPER MULTIPORE HZ-H (trade name, manufactured by Tosoh Corp., 4.6 mm ID×15 cm) columns, and using tetrahydrofuran (THF) as an eluent. GPC was carried out under the conditions of a sample concentration of 0.35% by mass, a flow rate of 0.35 mL/min, a sample injection amount of 10 μL, and a measurement temperature of 40° C., using an IR detector. The calibration curve was produced using “standard sample TSK standard polystyrene” manufactured by Tosoh Corp., including eight samples of “F-40,” “F-20,” “F-4,” “F-1,” “A-5000,” “A-2500,” “A-1000,” and “n-propylbenzene.”

(Synthesis of Polymeric Dispersant P-1)

In a 1000-mL three-necked flask equipped with a stirrer and a cooling tube, 88 g of methyl ethyl ketone was placed and heated to 72° C. under a nitrogen atmosphere. A solution prepared by dissolving 0.85 g of dimethyl 2,2′-azobisisobutyrate, 60 g of benzyl methacrylate, 10 g of methacrylic acid, and 30 g of methyl methacrylate in 50 g of methyl ethyl ketone was added dropwise to the flask over 3 hours. After completion of the dropwise addition, the reaction mixture was further allowed to react for one hour, and then a solution prepared by dissolving 0.42 g of dimethyl 2,2′-azobisisobutyrate in 2 g of methyl ethyl ketone was added to the reaction mixture. The temperature of the mixture was raised to 78° C., and the mixture was heated for 4 hours. The reaction solution thus obtained was reprecipitated two times in a large excess of hexane, and a resin precipitated therefrom was dried. Thus, 96 g of a polymeric dispersant P-1 was obtained.

The composition of the resin thus obtained was verified by ¹H-NMR, and the weight average molecular weight (Mw) determined by GPC was 44,600. Furthermore, the acid value was determined by the method described in HS Standards (HS K0070: 1992), and the acid value was found to be 65.2 mg KOH/g. The numbers accompanying the respective constituent units of the polymeric dispersant P-1 shown below represent the mass proportions.

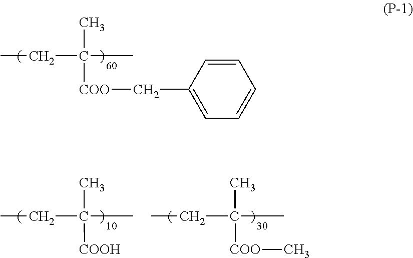

(Preparation of Pigment Dispersion C)

Ten parts of Pigment Blue 15:3 (trade name: PHTHALOCYANINE BLUE A220, manufactured by Dainichiseika Color & Chemicals Manufacturing Co., Ltd.), 5 parts of the polymeric dispersant P-1, 42 parts of methyl ethyl ketone, 5.5 parts of a 1 Normal aqueous NaOH solution, and 87.2 parts of ion-exchanged water were mixed, and the mixture was dispersed for 2 to 6 hours by a bead mill using 0.1-mmφ zirconia beads.

The dispersion thus obtained was treated to remove methyl ethyl ketone at 55° C. under reduced pressure, and some of water was further removed. Subsequently, the dispersion was subjected to centrifugation at 8000 rpm for 30 minutes using a HIGH SPEED REFRIGERATED CENTRIFUGE 7550 (trade name, manufactured by Kubota Corp.) and using a 50-mL centrifuge tube, and thus the supernatant excluding the precipitates was collected. Subsequently, the pigment concentration was determined from an absorbance spectrum, and thus a pigment dispersion C of resin-coated pigment particles (pigment coated with a polymeric dispersant) having a pigment concentration of 10.2% by mass was obtained.

(Preparation of Pigment Dispersion M)

A pigment dispersion M of resin-coated pigment particles (pigment coated with a polymeric dispersant) was prepared in the same manner as in the preparation of the pigment dispersion C, except that Pigment Red 122 was used instead of the Pigment Blue 15:3 used in the preparation of the pigment dispersion C.

(Preparation of Pigment Dispersion Y)

A pigment dispersion Y was prepared in the same manner as in the preparation of the pigment dispersion C, except that Pigment Yellow 74 was used instead of the Pigment Blue 15:3 used in the preparation of the pigment dispersion C, and the amount of addition of the polymeric dispersant was changed to 4.0 g in terms of solids content.

(Preparation of Pigment Dispersion K)

A pigment dispersion K was prepared in the same manner as in the preparation of the pigment dispersion C, except that carbon black (trade name: NIPEX160-IQ, manufactured by Degussa GmbH) was used instead of the Pigment Blue 15:3 used in the preparation of the pigment dispersion C, and the amount of addition of the polymeric dispersant was changed to 3.0 g in terms of solids content.

(Preparation of Self-Dispersing Polymer Particles B-01)

In a 2-liter three-necked flask equipped with a stirrer, a thermometer, a reflux cooling tube and a nitrogen gas inlet tube, 360.0 g of methyl ethyl ketone was introduced, and the temperature was raised to 75° C. under a nitrogen atmosphere. While the temperature in the reaction vessel was maintained at 75° C., a mixed solution containing 180.0 g of phenoxyethyl acrylate, 162.0 g of methyl methacrylate, 18.0 g of acrylic acid, 72 g of methyl ethyl ketone, and 1.44 g of “V-601” (trade name, manufactured by Wako Pure Chemical Industries, Ltd.) was added dropwise to the flask at a constant rate such that the dropwise addition was completed in 2 hours. After completion of the dropwise addition, a solution containing 0.72 g of “V-601” and 36.0 g of methyl ethyl ketone was added to the flask, and the mixture was stirred for 2 hours at 75° C. Subsequently, a solution containing 0.72 g of “V-601” and 36.0 g of isopropanol was added to the flask, and the mixture was stirred for 2 hours at 75° C. Subsequently, the temperature of the mixture was raised to 85° C., and stirring was continued for another 2 hours. The weight average molecular weight (Mw) of the copolymer thus obtained was 64,000 (calculated by GPC relative to polystyrene standards; the columns used were TSKGEL SUPER HZM-H, TSKGEL SUPER HZ4000, and TSKGEL SUPER HZ200 (all trade names, manufactured by Tosoh Corp.)), and the acid value was 38.9 (mg KOH/g).

Subsequently, 668.3 g of the polymer solution was weighed, and 388.3 g of isopropanol and 145.7 mL of a 1 mol/L aqueous NaOH solution were added to the polymer solution. Then, the temperature inside the reaction vessel was raised to 80° C. Subsequently, 720.1 g of distilled water was added dropwise at a rate of 20 mL/min, and the reaction mixture was dispersed in water. Thereafter, the aqueous dispersion was maintained for 2 hours at a temperature inside the reaction vessel of 80° C., for 2 hours at 85° C., and for 2 hours at 90° C. under atmosphere pressure. Subsequently, the pressure inside the reaction vessel was decreased, and 913.7 g in total of isopropanol, methyl ethyl ketone and distilled water was distilled off. Thus, an aqueous dispersion (emulsion) of self-dispersing polymer particles B-01 at a solids concentration of 28.0% was obtained. In addition, the numbers accompanying the respective constituent units of the self-dispersing polymer particles B-01 shown below represent the mass proportions.

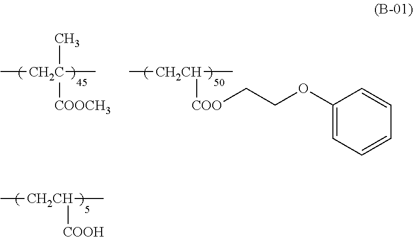

<Preparation of Ink Composition>

The pigment dispersions and aqueous dispersions of the self-dispersing polymer particles B-01 obtained as described above were used, and the respective components were mixed to obtain the compositions indicated in the following Table 1. The mixtures were filtered through 5-μm PVDF filters (trade name: MILLEX SV, manufactured by Millipore Corp., diameter 25 mm) using plastic disposable syringes, and thus ink compositions C1, M1, Y1 and K1 were obtained.

The pH value indicated in the Table 1 was measured by using a pH meter (trade name: WM-50EG, manufactured by DKK-Toa Corp.). The surface tension was measured using a FACE automatic surface tension meter (trade name: CBVP-Z, manufactured by Kyowa Interface Science Co., Ltd.).

TABLE 1

| Ink composition | C1 | M1 | Y1 | K1 |
|---|---|---|---|---|
| Cyan pigment (pigment | 4% | — | — | — |
| dispersion C was used) | | | | |
| Magenta pigment | — | 4% | — | — |
| (pigment dispersion M | | | | |
| was used) | | | | |
| Yellow pigment | — | — | 4% | — |
| (pigment dispersion Y | | | | |
| was used) | | | | |
| Black pigment (pigment | — | — | — | 4% |
| dispersion K was used) | | | | |
| Polymeric dispersant | 2% | 2% | 2% | 2% |
| P-1 | | | | |
| SUNNIX GP-250 | 10% | 10% | 10% | 10% |
| (manufactured by Sanyo | | | | |
| Chemical Laboratory | | | | |
| Co., Ltd.) | | | | |
| Tripropylene glycol | 5% | 5% | 5% | 5% |
| monomethyl ether | | | | |
| ORFIN E1010 | 1% | 1% | 1% | 1% |
| (manufactured by Nissin | | | | |
| Chemical Co., Ltd.) | | | | |
| Self-dispersing polymer | 4% | 4% | 4% | 4% |
| particles B-01 (solids | | | | |
| content) | | | | |
| Water | 74% | 74% | 74% | 74% |
| Ink composition: pH | 8.7 | 8.6 | 8.4 | 8.5 |
| Ink composition: surface | 34.6 | 35.2 | 35.1 | 34.8 |
| tension (mN/m) | | | | |

### Example 1

### Preparation of Treatment Liquid

(Preparation of Treatment Liquid A)

The following components were mixed, and a treatment liquid A was prepared.

| | |
|---|---|
| Orthophosphoric acid (85% aqueous solution) | 12.47% |
| (first aggregating agent) | |
| Malonic acid (second aggregating agent) | 11.25% |
| Diethylene glycol | 4% |
| Triethylene glycol monomethyl ether | 4% |
| Ion-exchanged water | Balance |

The pH of the treatment liquid A was measured using a pH meter (trade name: WM-50EG, manufactured by DKK-Toa Corp.), and the pH value was found to be 0.9.

(Preparation of Treatment Liquids B to L)

Treatment liquids B to L were prepared by changing the type and amount of the aggregating agents used in the formulation of the treatment liquid A. The formulations and pH are indicated in the following Table 2. The pH values indicated in the Table 2 were measured using a pH meter (trade name: WM-50EG, manufactured by DKK-Toa Corp.).

In addition, the first dissociation constant pKa of malic acid is 3.23 (25° C.) (“Kagaku Binran (Handbook of Chemistry)—Fundamentals II, Revised 5^{th} Edition,” edited by the Chemical Society of Japan, Maruzen Co., Ltd., 2004).

TABLE 2

| Treatment liquid | | A | B | C | D | E | F | G | H | I | J | K | L |
|---|---|---|---|---|---|---|---|---|---|---|---|---|---|
| First | Orthophosphoric | 12.47% | — | 12.47% | — | 12.47% | 24.95% | — | — | 12.47% | — | — | — |
| aggregating | acid (85% | | | | | | | | | | | | |
| agent | aqueous solution) | | | | | | | | | | | | |
| | Hypophosphorous | — | — | — | 22.31% | — | — | — | — | — | — | — | — |
| | acid (phosphinic | | | | | | | | | | | | |
| | acid, 32% | | | | | | | | | | | | |
| | aqueous solution) | | | | | | | | | | | | |
| | L(+)-tartaric acid | — | 16.23% | — | — | — | — | — | — | — | — | — | — |
| Second | Malonic acid | 11.25% | — | — | 11.25% | — | — | 11.25% | 11.25% | — | — | 22.5% | — |
| aggregating | Citric acid | — | 13.85% | — | — | — | — | — | — | — | — | — | — |
| agent | Metaphosphoric | — | — | — | — | — | — | 8.7% | — | — | — | — | — |
| | acid (35% | | | | | | | | | | | | |
| | aqueous solution) | | | | | | | | | | | | |
| | Polyphosphoric | — | — | — | — | — | — | — | 8.7% | — | — | — | — |
| | acid (37% | | | | | | | | | | | | |
| | aqueous solution) | | | | | | | | | | | | |
| | Nitric acid (60% | — | — | — | — | 11.36% | — | — | — | — | — | — | — |
| | aqueous solution) | | | | | | | | | | | | |
| | Magnesium | — | — | 12.5% | — | — | — | — | — | — | — | — | 25% |
| | nitrate | | | | | | | | | | | | |
| | hexahydrate | | | | | | | | | | | | |

| | | | | | | | | | | | | |
|---|---|---|---|---|---|---|---|---|---|---|---|---|
| Malic acid | — | — | — | — | — | — | — | — | 14.5% | 29% | — | — |
| Diethylene glycol | 4% | 4% | 4% | 4% | 4% | 4% | 4% | 4% | 4% | 4% | 4% | 4% |
| Triethylene glycol monomethyl | 4% | 4% | 4% | 4% | 4% | 4% | 4% | 4% | 4% | 4% | 4% | 4% |
| ether | | | | | | | | | | | | |
| Ion-exchanged water | Balance | Balance | Balance | Balance | Balance | Balance | Balance | Balance | Balance | Balance | Balance | Balance |
| Treatment liquid: pH | 0.88 | 0.86 | 1.02 | 0.87 | 0.82 | 0.81 | 0.79 | 0.74 | 0.89 | 1.16 | 0.95 | 5.3 |

<Image Forming>

Unless particularly stated otherwise, TOKUBISHI ART (trade name, manufactured by Mitsubishi Paper Mills, Ltd.) of A4 size was used as the recording medium, and the ink compositions C1, M1, Y1 and K1 and the treatment liquids A to L were used, to form images under the conditions described below. The image forming process was carried out such that ink droplet ejection was initiated within 10 seconds after the treatment liquid applying step.

(Treatment Liquid Applying Step)

Each of the treatment liquids was coated on the surface of the recording medium in an amount of coating of 1.7 g/m² using a coating bar, immediately before the ink droplet ejection onto the recording medium.

Next, the recording medium to which the treatment liquid had been applied was dried under the conditions described below.

—Drying Conditions for Treatment Liquid (Air Blow Drying)—
Blow speed: 15 m/s
Temperature: The recording medium was heated through the rear surface of the recorded surface using a contact type flat heater, such that the surface temperature of the recording medium reached 60° C.
Air blow region: 450 mm (drying time 0.7 seconds)

(Ink Applying Step)

Four-color single pass image recording was carried out under the conditions described below, on the recording medium to which each of the treatment liquids had been applied. The images that were drawn were changed for each of the evaluation items as will be described below.
Head: A 1,200 dpi/20-inch width piezo full-line head was disposed for each of four colors.
Amount of ejected liquid droplets: 2.4 pL
Drive frequency: 30 kHz (recording medium conveying speed: 635 mm/sec)

Next, the recording medium to which the ink had been applied was dried under the conditions described below.

—Drying Conditions for Ink (Air Blow Drying)—
Blow speed: 15 m/sec
Temperature: The recording medium was heated through the rear surface of the recorded surface using a contact type flat heater, such that the surface temperature of the recording medium reached 60° C.
Air blow region: 640 mm (drying time 1 second)

(Heating and Fixing Step)

Subsequently, a heating and fixing treatment was carried out under the conditions described below, and samples having an image formed on the recording medium were obtained.

—Heating and Fixing Conditions—
Silicon rubber roller (hardness 50°, nip width 5 mm)
Roller temperature: 90° C.
Pressure: 0.8 MPa

<Evaluation>

Evaluations were carried out for the evaluation items described below. The results are presented in Table 3.

(Aggregatability)

Halftone dots were drawn with the ink composition Y1, and thus a monochromatic yellow dot image was obtained. Separately, a uniform solid image was drawn with the ink composition C1, and then halftone dots were drawn on the solid image using the ink composition Y1 under the same conditions as used for the drawing of the monochromatic dots. Thus, an image of yellow dots (secondary color dots) on a cyan solid image was obtained.

For 100 monochromatic yellow dots and 100 secondary color dots, the circle equivalent diameter was measured using a dot analyzer (trade name: DA-6000, manufactured by Oji Scientific Instruments Co., Ltd.), and the average value of 100 dots was taken as the dot diameter.

As the difference between the monochromatic yellow dot diameter and the secondary color dot diameter (Δdot diameter) is smaller, a uniform image having dots of each color with complete dot diameter may be drawn, which is preferable. An evaluation was performed according to the following evaluation criteria.

—Evaluation Criteria—

5: The Δdot diameter is 0 μm or more and less than 1 μm.

4: The Δdot diameter is 1 μm or more and less than 2 μm.

3: The Δdot diameter is 2 μm or more and less than 3 μm.

2: The Δdot diameter is 3 μm or more and less than 5 μm.

1: The Δdot diameter is 5 μm or more.

(Gloss Unevenness of Image Areas)

A uniform solid image was drawn using the ink composition K1. Furthermore, the same image was drawn on the rear surface under the same conditions. The surfaces of 10 sheets of the sample thus obtained were evaluated by visual inspection according to the following evaluation criteria.

—Evaluation Criteria—

3: For all of the samples, the gloss in the image areas is uniform, and gloss unevenness is not observed.

2: For some of the samples, changes in the gloss are observed at the edges of the image areas.

1: For all of the samples, gloss unevenness in the image areas is observed.

(Finger Contact Gloss Unevenness)

The samples obtained for the evaluation of the gloss unevenness in the image areas, were treated such that an image area on the surface was touched with a finger for 30 seconds, and then the sample was left to stand for one minute at room temperature. Changes in the gloss of the image in the vicinity of the site touched by a finger were evaluated by visual inspection according to the following evaluation criteria.

—Evaluation Criteria—

3: Changes in the gloss are not observed.

2: Slight changes in the gloss are observed in the vicinity of the site touched by a finger.

1: Changes in the gloss occur in the vicinity of the site touched by a finger, and gloss unevenness is visible.

(Scratch Resistance of Image)

The sample in which secondary color dots were drawn, obtained for the evaluation of aggregatability, was used for image forming. Subsequently, after a lapse of 30 minutes under constant temperature and constant humidity conditions, a recording medium that was not used for drawing was superimposed on the sample and was rubbed 10 times under a load of 240 g/cm². Thus, the degree of susceptibility to damages of the images was examined. The evaluation was performed according to the following evaluation criteria.

—Evaluation Criteria—

4: The rubbed areas do not have any scratches, just like the unrubbed areas.

3: The surfaces of the rubbed areas are slightly damaged, but the image itself is not damaged and is free of problems for practical use.

2: The surfaces of the rubbed areas are slightly peeled off, and very fine scratches are seen. There are limitations in practical use.

1: The surfaces of the rubbed areas are peeled off, and white background of the recording medium is partially exposed. Practical use is impossible.

(Image Sharpness)

An image entitled portrait (sample No. 1, Reference symbol of image: N1) of high precision color digital standard image data (ISOMS-SCID) was drawn using, as a recording medium, OK TOPCOAT+ (trade name, manufactured by Oji Paper Co., Ltd.) of A4 size. Thus, the image sharpness was visually observed and evaluated according to the following evaluation criteria.

—Evaluation Criteria—

3: The image is reproduced vividly.

2: The image is reproduced, but is dull.

1: The image is not sharp.

(Storage Stability)

For each of the treatment liquids, the viscosity was measured, subsequently the treatment liquid was stored for 2 weeks in a constant temperature chamber at 60° C., and the viscosity was measured again. The viscosity measurement was carried out under the conditions of 20° C. using a viscometer (trade name: TV-22, manufactured by Toki Sangyo Co., Ltd.).

The viscosity change rate was determined from the viscosity before storage η1 and the viscosity after storage for 2 weeks η2, based on the following formula. Thus, an evaluation of the storage stability was performed according to the following evaluation criteria.

Formula: (η1−η2)/η1×100

—Evaluation Criteria—

3: The viscosity change rate is 0% or more and less than 15%.

2: The viscosity change rate is 15% or more and less than 50%.

1: The viscosity change rate is 50% or more.

TABLE 3

| | Treatment liquid | | | | | | | | |
|---|---|---|---|---|---|---|---|---|---|
| | | Category | | | Finger | | | | |
| | | of | | | contact | | | | |
| | Acid or salt contained | aggregating | | Gloss | gloss | Scratch | Image | Storage | |
| | in treatment liquid | agent | Aggregatability | unevenness | unevenness | resistance | sharpness | stability | Remarks |
| A | Orthophosphoric acid | (A) | 5 | 3 | 3 | 4 | 3 | 3 | Invention |
| | Malonic acid | (b-1) | | | | | | | |
| B | L(+)-tartaric acid | (A) | 4 | 3 | 3 | 4 | 3 | 3 | Invention |
| | Citric acid | (b-1) | | | | | | | |
| C | Orthophosphoric acid | (A) | 5 | 3 | 3 | 4 | 3 | 3 | Invention |
| | Magnesium nitrate | (b-3) | | | | | | | |
| | hexahydrate | | | | | | | | |
| D | Hypophosphoric acid | (A) | 4 | 3 | 3 | 3 | 3 | 3 | Invention |
| | Malonic acid | (b-1) | | | | | | | |
| E | Orthophosphoric acid | (A) | 4 | 3 | 3 | 3 | 3 | 3 | Invention |
| | Nitric acid | (b-2) | | | | | | | |
| F | Orthophosphoric acid | (A) | 1 | 3 | 3 | 4 | 1 | 3 | Comparative |
| | | | | | | | | | Example |
| G | Malonic acid | (b-1) | 4 | 3 | 3 | 3 | 2 | 1 | Comparative |
| | Metaphosphoric acid | (b-2) | | | | | | | Example |
| H | Malonic acid | (b-1) | 4 | 3 | 3 | 3 | 1 | 1 | Comparative |
| | Polyphosphoric acid | (b-2) | | | | | | | Example |
| I | Orthosphosphoric acid | (A) | 2 | 2 | 2 | 2 | 1 | 3 | Comparative |
| | Malic acid | — | | | | | | | Example |
| J | Malic acid | — | 3 | 1 | 1 | 1 | 1 | 3 | Comparative |
| | | | | | | | | | Example |
| K | Malonic acid | (b-1) | 5 | 1 | 1 | 2 | 1 | 2 | Comparative |
| | | | | | | | | | Example |
| L | Magnesium nitrate | (b-3) | 2 | 2 | 2 | 1 | 2 | 3 | Comparative |
| | hexahydrate | | | | | | | | Example |

As it is obvious from Table 3, the ink set and image forming method of the invention have satisfactory ink aggregatability and effectively suppress the occurrence of gloss unevenness and finger contact gloss unevenness in the image areas. Furthermore, according to the ink set and image forming method of the invention, the images obtained immediately after image recording have good scratch resistance, and the images thus formed are sharp. In addition, the treatment liquid included in the ink set of the invention has satisfactory storage stability.

### Example 2

The mass ratio of the first aggregating component (A) and the second aggregating component (B) was examined.

<Preparation of Treatment Liquid>

(Preparation of Treatment Liquid A1)

The following components were mixed, and thus a treatment liquid A1 was prepared.

| | |
|---|---|
| Orthophosphoric acid (85% aqueous solution) | 1.25% |
| (first aggregating agent) | |
| Malonic acid (second aggregating agent) | 21.38% |
| Diethylene glycol | 4% |
| Triethylene glycol monomethyl ether | 4% |
| Ion-exchanged water | Balance |

The pH of the treatment liquid A1 was measured using a pH meter (trade name: WM-50EG, manufactured by DKK-Toa Corp.), and the pH value was found to be 0.88

(Preparation of Treatment Liquids A2 to A8)

Treatment liquids A2 to A8 were prepared by changing the type and amount of the aggregating agents used in the formulation of the treatment liquid A1 as indicated in the following Table 4. The pH value indicated in the Table 4 was measured by using a pH meter (trade name: WM-50EG, manufactured by DKK-Toa Corp.).

<Image Forming and Evaluation>

Images for evaluating the “aggregatability,” “gloss unevenness in image areas,” “finger contact gloss unevenness,” “scratch resistance of image,” and “image sharpness” were formed in the same manner as in Example 1 and were evaluated according to the same evaluation methods. The results are presented in the following Table 4.

TABLE 4

| | Treatment liquid | | | | | | | | |
|---|---|---|---|---|---|---|---|---|---|
| | | Amount | | | | | Finger | | |
| | Acid or polyvalent metal | added to | | | | | contact | | |
| | salt contained in | treatment | Mass ratio | | | Gloss | gloss | Scratch | Image |
| | treatment liquid | liquid | (A):(B) | pH | Aggregatability | unevenness | unevenness | resistance | sharpness |
| A1 | Orthophosphoric acid | 1.4% | 0.5:9.5 | 0.88 | 5 | 3 | 2 | 2 | 2 |
| | Malonic acid | 22.8% | | | | | | | |
| A2 | Orthophosphoric acid | 2.8% | 1:9 | 0.87 | 5 | 3 | 3 | 3 | 3 |
| | Malonic acid | 21.6% | | | | | | | |
| A3 | Orthophosphoric acid | 5.6% | 2:8 | 0.88 | 5 | 3 | 3 | 4 | 3 |
| | Malonic acid | 19.2% | | | | | | | |
| A4 | Orthophosphoric acid | 8.5% | 3:7 | 0.85 | 5 | 3 | 3 | 4 | 3 |
| | Malonic acid | 16.8% | | | | | | | |
| A5 | Orthophosphoric acid | 19.8% | 7:3 | 0.81 | 5 | 3 | 3 | 4 | 3 |
| | Malonic acid | 7.2% | | | | | | | |
| A6 | Orthophosphoric acid | 22.6% | 8:2 | 0.80 | 4 | 3 | 3 | 4 | 3 |
| | Malonic acid | 4.8% | | | | | | | |
| A7 | Orthophosphoric acid | 25.4% | 9:1 | 0.78 | 4 | 3 | 3 | 4 | 3 |
| | Malonic acid | 2.4% | | | | | | | |
| A8 | Orthophosphoric acid | 26.8% | 9.5:0.5 | 0.77 | 3 | 3 | 3 | 4 | 2 |
| | Malonic acid | 1.2% | | | | | | | |

*A 85% aqueous solution of orthophosphoric acid was used.

As it is obvious from Table 4, the ink set and image forming method of the invention are excellent in the ink aggregatability, suppression of the occurrence of gloss unevenness of image areas and finger contact gloss unevenness, scratch resistance of images obtainable immediately after image recording, and image sharpness. It was found that these effects are more excellent in the case where the mass ratio of the first aggregating agent and the second aggregating agent is 1:9 to 9:1.

### Example 3

The type of the recording medium was examined.

The recording medium indicated in the following Table 5 were used, and the treatment liquid A and the treatment liquid L were used as the treatment liquid. Images for evaluating the “aggregatability,” “gloss unevenness in image areas,” “finger contact gloss unevenness,” “scratch resistance of image,” and “image sharpness” were formed in the same manner as in Example 1 and were evaluated according to the same evaluation methods. The results are presented in the following Table 5. In addition, the details of the recording medium are as follows.
OK TOPCOAT+: manufactured by Oji Paper Co., Ltd., coated paper (gloss)
N SILVER DIA: manufactured by Nippon Paper Group, Inc., coated paper (matt)
AURORA S: manufactured by Nippon Paper Group, finely coated paper
SHIRAOI: manufactured by Nippon Paper Group, non-coated paper

TABLE 5

| | | | | Finger contact | | | |
|---|---|---|---|---|---|---|---|
| Treatment | Recording | | Gloss | gloss | Scratch | Image | |
| liquid | medium | Aggregatability | unevenness | unevenness | resistance | sharpness | Remarks |
| A | OK | 5 | 3 | 3 | 4 | 3 | Invention |
| | TOPCOAT+ | | | | | | |
| | N SILVER | 5 | 3 | 3 | 4 | 3 | |
| | DIA | | | | | | |
| | AURORA S | 5 | 3 | 3 | 4 | 3 | |
| | SHIRAOI | 5 | 3 | 3 | 4 | 2 | |
| L | OK | 5 | 1 | 1 | 2 | 1 | Comparative |
| | TOPCOAT+ | | | | | | Example |
| | N SILVER | 5 | 1 | 1 | 1 | 1 | |
| | DIA | | | | | | |
| | AURORA S | 5 | 2 | 1 | 2 | 1 | |
| | SHIRAOI | 5 | 2 | 2 | 3 | 2 | |

As it is obvious from Table 5, even though any of coated paper, finely coated paper and non-coated paper is used, the ink set and image forming method of the invention have good ink aggregatability and effectively suppress the occurrence of gloss unevenness and finger contact gloss unevenness in the image areas. Furthermore, according to the ink set and image forming method of the invention, even though any of coated paper, finely coated paper and non-coated paper is used, the scratch resistance of the images obtained immediately after image recording is excellent, and the images formed are sharp. When coated paper and finely coated paper are used, the images formed are even sharper.

The fixing liquid described in JP-A No. 2002-29141 does not have an ink aggregatability that is capable of coping with the increase in speed of inkjet recording, and has a problem that gloss unevenness in the image areas is prone to occur.

Furthermore, it was found that the ink set for inkjet recording having a reaction liquid containing acid, results in the occurrence of gloss unevenness in the image areas when a coated paper (art paper or coated paper) is used as the recording medium. This occurrence of gloss unevenness is believed to be resulting from the organic acid calcium salt generated when the acid contained in the reaction liquid dissolves the calcium carbonate contained in the coating layer (also called as coat layer) of the coated paper, and the dissolved calcium reacts with the organic acid in the reaction liquid. Since the water-solubility of the organic acid calcium salt thus formed is high, the calcium salt is dissolved by the aqueous solvent of the ink that is applied later, and diffusion (movement of organic acid calcium salt) occurs in the image areas. It is speculated that as the aqueous solvent is dried, precipitation occurs at the recording medium surface of the image areas, and there occurs gloss unevenness in the image areas. Furthermore, this gloss unevenness is such that although the occurrence of gloss unevenness is not recognized in the printed matter obtained immediately after printing, the gloss unevenness occurs even when the organic acid calcium salt is present near the recording medium surface of image areas, for example, when moisture is applied to the recorded image or when the recorded image is touched with a wet finger. Thus, this causes a problem in the handling of the recording medium. Furthermore, due to the high water-solubility of the organic acid calcium salt, the coat layer is weakened immediately after an aqueous ink is applied, and there is posed a problem with the scratch resistance of the images obtained immediately after image recording.

It is an object of the invention to solve various problems of the related art and to achieve the following purposes.

That is, according to the present invention, there are provided an ink set which has satisfactory ink aggregatability and is capable of suppressing the occurrence of gloss unevenness in the image areas, and an image forming method which is capable of increasing the speed of image forming and suppressing the occurrence of gloss unevenness in the image areas.

What is claimed is:

1. An ink set comprising an ink containing at least a coloring material, and a treatment liquid including at least one first aggregating agent selected from the following group (A) and at least one second aggregating agent selected from the following group (B), which is different from the group (A):
(A) orthophosphoric acid, phosphorous acid, hypophosphorous acid, pyrophosphoric acid, tartaric acid and salts thereof; and
(B) an organic acid having a first dissociation constant pKa of 3.2 or less, or a salt thereof (b-1), an inorganic acid or a salt thereof (b-2), and a polyvalent metal salt (b-3).

2. The ink set of claim 1, wherein the mass ratio of the first aggregating agent to the second aggregating agent in the treatment liquid is from 1:9 to 9:1.

3. The ink set of claim 1, wherein the treatment liquid contains a hydrophilic organic solvent.

4. The ink set of claim 1, wherein the coloring material is a pigment.

5. The ink set of claim 4, wherein the pigment is coated with a polymeric dispersant.

6. The ink set of claim 1, wherein the ink contains polymer particles.

7. The ink set of claim 6, wherein the polymer particles are self-dispersing polymer particles.

8. An image forming method comprising applying a treatment liquid on a recording medium, and applying an ink on the recording medium by an inkjet method and thereby recording an image, wherein the method uses the ink set of claim 1.

9. The image forming method of claim 8, further comprising heating the image recorded by applying the ink, and thereby fixing the image to the recording medium.

10. The image forming method of claim 9, wherein the recording medium has a support and a coating layer containing an inorganic pigment.

11. The image forming method of claim 10, wherein the inorganic pigment is at least one of silica, kaolin, clay, calcined clay, zinc oxide, tin oxide, magnesium sulfate, aluminum oxide, aluminum hydroxide, pseudo-boehmite, calcium carbonate, satin white, aluminum silicate, smectite, zeolite, magnesium silicate, magnesium carbonate, magnesium oxide, or diatomaceous earth.
